(19) United States
(12) Patent Application Publication
(10) Pub. No.: US 2025/0025778 A1
(43) Pub. Date: Jan. 23, 2025

(54) UNIVERSAL SERVER AND HOST SYSTEM

(71) Applicant: Unity Technologies SF, San Francisco, CA (US)

(72) Inventors: Timothy S. Condon, South San Francisco, CA (US); Vladimir Vukicevic, Auburn, CA (US)

(21) Appl. No.: 18/777,330

(22) Filed: Jul. 18, 2024

Related U.S. Application Data
(60) Provisional application No. 63/527,521, filed on Jul. 18, 2023.

(51) Int. Cl. A63F 13/355; A63F 13/358; A63F 13/52; G06T 15/20; G06T 17/00

(52) U.S. Cl. CPC A63F 13/355; A63F 13/52; G06T 15/20; G06T 17/005; A63F 13/358; G06T 2210/08; G06T 2210/36; G06T 2210/61

(57) ABSTRACT

A universal server and host system and method, the system configuring a universal server to transmit, to one or more universal hosts, asset and scene information to generate one or more local scene graphs, each local scene graph replicating a scene graph associated with a simulation running at the universal server and being associated with a local simulation running at a universal host. Upon receiving input from the one or more universal hosts, the universal server updates an internal state based on the received input, generate commands encoding changes to an output state, and transmits the commands to the one or more universal hosts for updating each local scene graph at its respective universal host, at least one local scene graph to be rendered at a local device associated with its respective universal host. The universal server and the one or more universal hosts are applications.

### CROSS REFERENCE TO RELATED APPLICATIONS

This application claims the benefit of U.S. Provisional Application 63/527,521, filed on Jul. 18, 2023, which is hereby incorporated by reference in its entirety.

### TECHNICAL FIELD

The disclosed subject matter relates generally to the technical fields of networking and graphics and, in one particular example, to a universal server and host system for 2D and/or 3D content use cases.

### BACKGROUND

Users and developers show continued interest in the next generation of networked multi-user games and applications, with particular emphasis on improving and augmenting the user experience by streamlining interactions and enabling novel use cases powered by dynamic, real-time 2D and 3D content.

### BRIEF DESCRIPTION OF THE SEVERAL VIEWS OF THE DRAWINGS

Some embodiments are illustrated by way of example and not limitation in the figures of the accompanying drawings.

FIG. 1 is a network diagram illustrating a system within which various example embodiments may be deployed.

FIG. 2 is a diagrammatic representation of a view of a universal server and host system, according to some embodiments.

FIG. 3 is a diagrammatic representation of the architecture of an application, according to some embodiments.

FIG. 4 is a diagrammatic representation of several views of a universal server and host system, according to some embodiments.

FIG. 5 is a diagrammatic representation of a view of a universal server and host system, according to some embodiments.

FIG. 6 is a diagrammatic representation of a view of a universal server and host system, according to some embodiments.

FIG. 7 is a diagrammatic representation of a view of universal server and host system, according to some embodiments.

FIG. 8 is a diagrammatic representation of a view of a universal server and host system, according to some embodiments.

FIG. 9 is a diagrammatic representation of a view of a universal server and host system, according to some embodiments.

FIG. 10 is a diagrammatic representation of a view of a universal server and host system, according to some embodiments.

FIG. 11 is a diagrammatic representation of a view of a universal server and host system, according to some embodiments.

FIG. 12 is a diagrammatic representation of a view of a universal server and host system, according to some embodiments.

FIG. 13 is a diagrammatic representation of a view of a universal server and host system, according to some embodiments.

FIG. 14 is a diagrammatic representation of a view of a universal server and host system, according to some embodiments.

FIG. 15 is a diagrammatic representation of a view of a universal server and host system 200, according to some embodiments.

FIG. 16 is a diagrammatic representation of a view of an application-host data flow in the context of a universal server and host system, according to some embodiments.

FIG. 17 is a diagrammatic representation of a view of an application-host data flow in the context of a universal server and host system, according to some embodiments.

FIG. 18 is a diagrammatic representation of a view of an application-host data flow in the context of a universal server and host system, according to some embodiments.

FIG. 19 is a diagrammatic representation of a view of an application-host data flow in the context of a universal server and host system, according to some embodiments.

FIG. 20 is a diagrammatic representation of a view of an application-host data flow in the context of a universal server and host system, according to some embodiments.

FIG. 21 is a diagrammatic representation of a view of an application-host data flow in the context of a universal server and host system, according to some embodiments.

FIG. 22 is a diagrammatic representation of a command pipeline as implemented by a universal server and host system, according to some embodiments.

FIG. 23 is a diagrammatic representation of a networked pipeline as implemented by a universal server and host system, according to some embodiments.

FIG. 24 is a flowchart illustrating a method as implemented by a universal server and host system, according to some embodiments.

FIG. 25 is a block diagram illustrating components of a machine, according to some embodiments, able to read instructions from a machine-readable medium (e.g., a machine-readable storage medium) and perform any one or more of the methodologies discussed herein.

FIG. 26 is a block diagram illustrating an example of a software architecture that may be installed on a machine, according to some embodiments.

### DETAILED DESCRIPTION

Networked multi-user games and/or applications (apps) present significant technical challenges compared to single-user software. For example, networked multi-user games and/or applications must enforce synchronization across multiple devices in real time, manage limited bandwidth, network lag and/or other connectivity issues, support late joining clients and dropped clients, detect and prevent cheating, maintain system security, and so forth.

Existing networked games, such as those with a “thin client” architecture, replicate input and output commands between a client (such as a game client) and an authoritative host. However, current network architectures for games and/or 3D content and/or current game clients are often single purpose or bespoke. For example, an instance of a current networked game (e.g., Quake 3) running on a local device is designed to connect to other instances of the same networked game (e.g., another Quake 3 instance running on another device) in a manner that requires users to install the games and/or to ensure a match of the installed versions. However, current solutions involving a user's installation of a particular network game do not allow the user to switch to another game without a subsequent install (e.g., being able to play Quake 3 does not mean the user can play another game, such as Call of Duty). Furthermore, current game clients in existing networked games often make constraining assumptions about game asset handling that do not enable universal game play. For example, current game networking solutions include real-time updates such as updated transform information and/or high-level state information, but assume that the assets or content (textures, meshes, audio files, etc.) are already present on the remote client.

Such assumptions underlying existing networked multi-user games or applications constrain the space of use cases. For example, such existing systems make it difficult to have transient or spontaneous interactions, such as metaverse interactions. The promise of the so-called metaverse is partially built on virtual interactions such as virtual reality (VR) or augmented reality (AR) users' virtual costumes or pets, or joining ad-hoc gaming interactions. Such interactions can involve people meeting up in a shared physical space (e.g., two people passing each other in the street) who would like to easily share virtual content. Such interactions would be ideally achievable with minimal development effort, and without requiring laborious installs for each pet, costume pack, game and so forth. However, current existing networking solutions do not enable such interactions, or do not support efficient versions of such interactions. Users of a typical existing networked application must download and install their own copy of the application before participating in an experience. Post-installation users frequently grapple with a stream of updates and patches that impede their ability to fully and/or consistently engage with a networked application.

Current networked games and/or networking solutions are also lacking with respect to supporting dynamic content, such as real-time 3D content. For example, Web-based 3D solutions such as WebGL are wrappers for the low level capabilities of a local machine and lack capabilities for simplifying multi-user real-time networking. Remote desktop apps and “zero-client” solutions send and receive input from a remote host, but the signal received back for display purposes usually takes the form of remotely rendered and streamed pixels, optionally augmented by compression techniques.

Overall, networked multi-user games and/or applications present multiple technical challenges. Existing networking solutions and/or networked applications only partially address or do not address the challenges above, while restricting the range of user experiences and/or use cases, and/or burdening the user with installs and updates.

Example embodiments described herein refer to a universal server and host system that implements a many-to-many client/server model that solves the technical challenges outlined above, as well as related technical challenges. In some embodiments, the universal server and host system enables the user to install a single application, a universal host, which can connect to and run a second application corresponding to a universal server. In some embodiments, the universal host can host one or more different games or other interactive applications, with core application logic being run on the universal server. In some embodiments, additional application logic (e.g., input or UI code to ensure responsive interactions) is run on the universal host. Users can thus observe, join and/or participate in a compliant experience with minimal application install and/or update efforts. This universal server and host system design greatly reduces distribution friction for networked experiences, and/or vastly simplifies the development and adoption of multiplayer applications and games.

In some embodiments, the universal server and host system enables servers and hosts to communicate using command handlers, corresponding to operators that can be assembled in pipelines and/or graphs (e.g., servers and/or hosts being able to function as command handlers themselves). The universal server and host system thus enables servers and hosts to be arranged and/or connected arbitrarily and/or dynamically, in parallel and/or serially, hierarchically, and/or distributed over users, apps, and/or devices. In some embodiments, the universal server and host system includes multispatial (or polyspatial) graph capabilities that can support such complex topologies. Furthermore, by treating universal servers, universal hosts and/or command handlers as building blocks, the universal server and host system enables a modular networking architecture (e.g., for 3D content, as seen below), in contrast to current rigid and/or bespoke networking architectures.

In some embodiments, the universal host is similar to a browser for 2D and/or 3D interactive content. The 3D-centric architecture of the universal host leads to significant performance advantages, along with interpolation, extrapolation, prediction, and real-time preview capabilities of the universal host that improve responsiveness and/or perceived performance.

In some embodiments, the universal server and host system greatly expands the reach of a software platform (such as Unity Technologies' software platform or parts thereof) onto different hardware platforms (e.g., various game console hardware platforms, various mobile device hardware consoles, various head mounted display hardware consoles, and the like). For example, if an application (e.g., a “universal player” application adhering to a universal host specification) can host any content, porting a game or application catalog (e.g., games and/or applications created using Unity Technologies' software platform, or parts thereof) to new hardware platforms becomes vastly simpler. A hardware platform that implements a performant version of a universal host will be able to bring all compliant content on the specific platform.

In some embodiments, compliant applications based on the universal server and host model are networked by default using a generalized many-to-many client/server model. Such a design helps end developers by converting the difficult problem of networked multi-player into a simpler local cooperation (“local co-op”) scenario involving multiple participants.

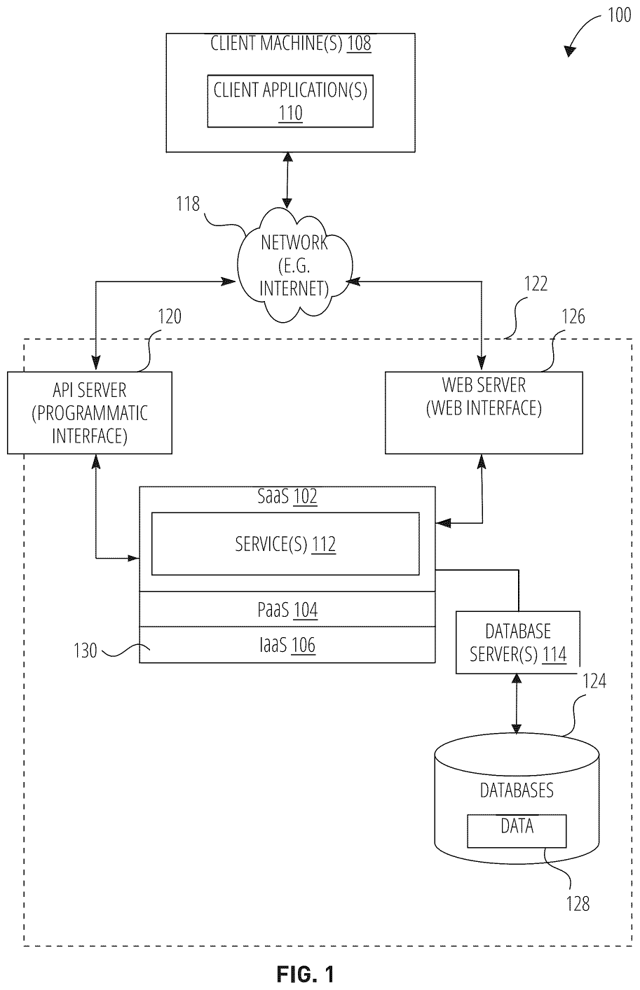

FIG. 1 is a network diagram depicting a system 100 within which various example embodiments described herein may be deployed. A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, contact center applications, digital content creation applications (e.g., game development applications) or game applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon an infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server services or applications 112 could also be implemented as standalone software programs. Additionally, although FIG. 1 depicts machine(s) 108 as being coupled to a single networked system 122, it will be readily apparent to one skilled in the art that client machine(s) 108, as well as client application(s) 110 (such as game applications), may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database server(s) 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data 128 (e.g., via one or more client applications). Various other navigation applications may be provided to supplement the search and browsing applications.

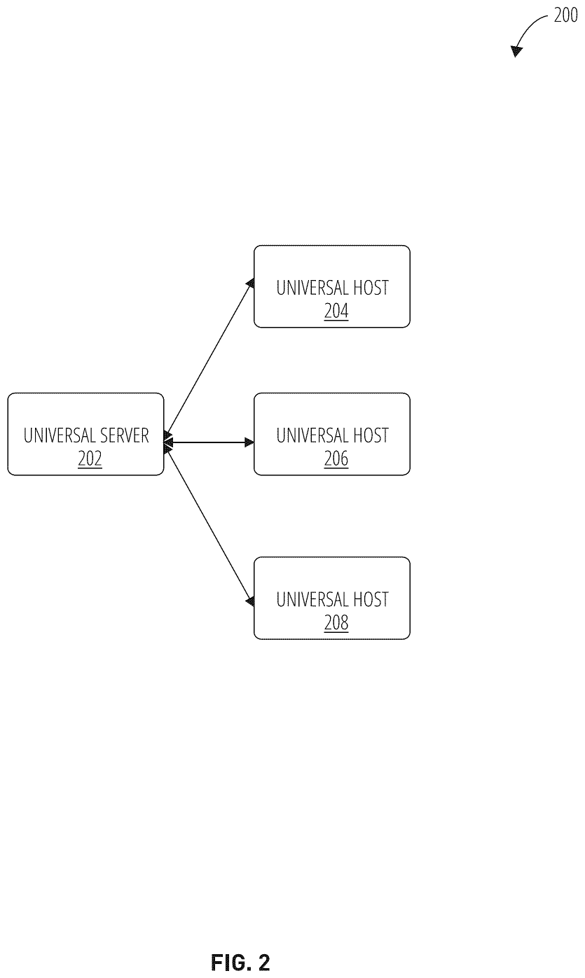

FIG. 2 is a diagrammatic representation of a view of a universal server and host system 200, according to some embodiments. In some embodiments, a universal server specification corresponds to a framework for building general network-capable software applications, with a universal server corresponding to an application that adheres to the universal server specification (e.g., universal server 202). A universal host is a standalone application that can connect to, display and interact with one or more universal servers. FIG. 2 showcases a universal server 202 interacting with universal hosts 204, 206, 208. In some embodiments universal server 202 can be on a local device or can connect remotely, for example using cloud computing capabilities. In some embodiments, universal hosts 204, 206 and/or 208 are installed on specific local devices. The universal server 202 and a universal host such as 204, 206 or 208 can be on the same local device, or connect remotely. By connecting several universal hosts to a universal server designed for multiple users, the universal server and host system 200 system enables software developers to develop multi-user applications as if all users were connecting to the same local machine, as the system abstracts the reality of remote users connecting to a centralized, authoritative universal server.

An example universal host 204 starts as a blank slate application (or app). In some embodiments, such a blank slate application is built around a general-purpose renderer. In some embodiments, the universal host 204 and/or universal server 202 support 2D content, 3D content, and/or hybrids of 2D and 3D content. The universal host 204 includes, in some embodiments, its own content and/or utilities including user interface (UI) utilities, manipulation utilities and so forth. In some embodiments, the universal host 204 starts out as corresponding to a mostly-empty scene. Upon connection to a universal server 202, the universal host 204 forwards to the universal server 202 received host-level input such as button presses, keystrokes, detected joint positions and other information received from the local device or operating system (OS). In some embodiments, the universal host 204 forwards to the universal server 202 the output of local prediction or extrapolation routines. Generalized prediction and correction information provided by universal host 204 provides baseline reliability and responsiveness capabilities for applications based the universal server and host model.

The universal server 202 replicates part of or all of a scene (e.g., a native scene corresponding to an application and/or game) to the one or more connected hosts, such as universal host 204. In some embodiments, the universal server 202 streams required assets and/or scene data, optionally on demand, to one or more connected hosts, where the scene is subsequently remotely reconstructed. Alternatively, the universal server 202 transmits to the one or more connected hosts information associated with locating the required assets, such as a URL to a content distribution network (CDN), content server, or other services. Assets can include meshes, textures, materials, rigging, and so forth (see, e.g., “ASSETS” in the GLOSSARY section). In some embodiments, the universal server 202 transmits, to the one or more connected hosts, scene data, including scene graph information. In some embodiments, scene data refers to runtime state information used to simulate and/or render a scene. Scene graph information can include entities (e.g., game objects, corresponding for example to scene graph nodes). Each entity includes a 2D and/or 3D transform, in the context of a transform hierarchy (e.g., including parent/child relationships). Each entity can be further characterized using one or more of a name, ID, lifecycle state information such as active/enabled/visible flags, debug information, and/or additional hierarchical relationships (e.g., namespace and/or physics hierarchies separate from the transform hierarchy). In some embodiments, scene data and/or scene graph information include components. A component is a modular element associated with an entity, which can be individually added to and/or removed from the entity. When added to an entity, the component is enabled to activate or turn off one or more specific behaviors (e.g., rendering a mesh, playing a sound, etc.). A component is characterized by properties and/or data, simulation behavior and/or rendering behavior (behaviors being encoded as functions associated with the component). Components include output components, simulation components, and more. Output components contribute to an application's final output (e.g., to rendering, audio and/or output signals). Simulation components are associated with an application's logic. Some components have both output component characteristics and simulation component characteristics (e.g., further discussion and component examples can be found in “COMPONENTS (SCENE DATA)” in the GLOSSARY section.) In some embodiments, the universal server replicates output components to one or more remote hosts (e.g., universal hosts 204, 206, 208, etc.) to recreate the scene, while simulation components are omitted. In some embodiments, choice simulation components can be replicated and/or sync-ed as well, for example to reduce host overheard.

If multiple universal hosts 204, 206, 208 are connected to the same universal server 202, the server can broadcast identical data to all connected hosts. This approach scales better than previous pixel-based approaches to the same problem (e.g., approaches that render and/or transmit unique pixels to each connected client).

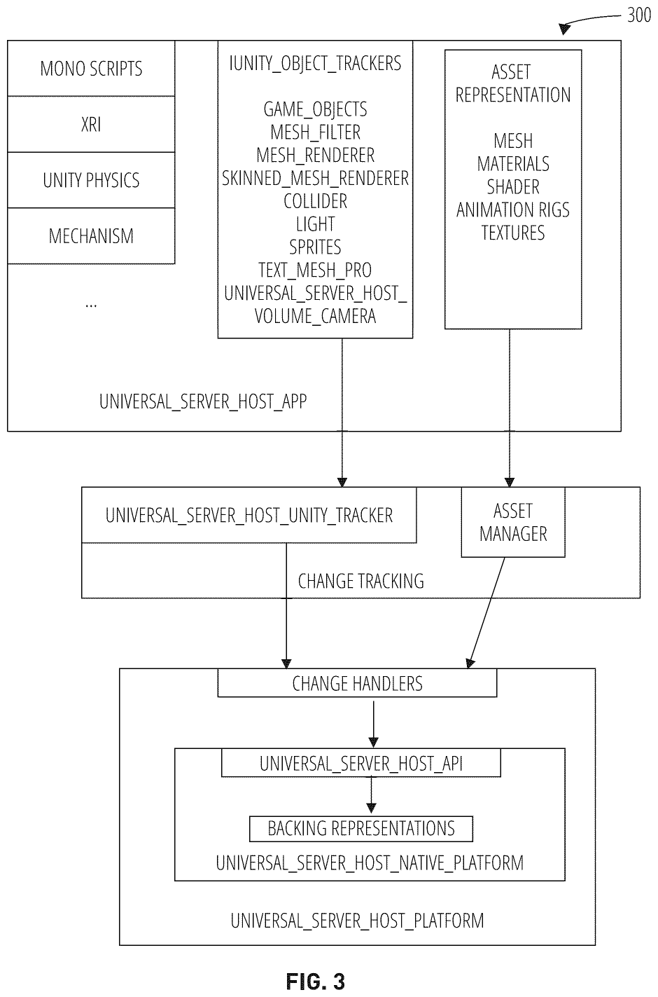

In some embodiments, universal server 202 receives input from at least one host (e.g., universal host 204). Universal server 202 processes the input as if received locally, updates its internal state accordingly, runs normal app-specific simulation, then serializes any changes to its output state, the changes being a result of the received and/or processed input and/or the passage of time. Such changes are encoded as commands, such as for example scene graph commands (for more examples, see FIG. 3 discussion). In some embodiments, the universal server 202 displays this output state and/or the updated scene locally. In some embodiments, the output state (e.g., including the scene graph commands) is sent to at least one universal host (e.g., universal host 204). Scene graph commands include asset updates, component updates and/or graphical states describing changes to the scene associated with the universal server 202 in a compact, lossless format. Asset updates include newly created, modified or destroyed meshes, textures or materials, animation clips and/or graphs, updates to particle system properties, and so forth. Component updates include transform updates, material property changes, collision information associated with graphical content or game objects (e.g., colliders), motion state associated with graphical content or game objects and so forth. In some embodiments, such commands corresponding to manipulating entities (game objects, transforms, mesh renderers and/or models, particle systems and more correspond to a set of high-level commands. Similarly, the above assets available to entities, game objects and/or components correspond to a set of high-level assets. Additionally, the universal server and host system 200 can accommodate low-level commands and/or assets, as described towards the end of the FIG. 2 description.

Upon receiving updates or scene graph commands from the universal server 202, the universal host 204 processes them as if they had been locally generated and applies them to the local version of a scene or hierarchy (e.g., a parallel scene or hierarchy) in order to sync it up with the scene and/or scene graph version on the universal server 202. The universal host 204 maintains and/or updates such a local version of a scene or hierarchy as part of a local simulation. When collision and motion state information is provided by the universal server 202, universal host 204 can use this data to maintain and update a simplified physics model used for interpolation, extrapolation, prediction, interaction preview, and/or collision-based input processing in order to improve performance and responsiveness in an application-agnostic manner. The updated scene is then rendered on the local device corresponding to the universal host 204. As noted above, the universal server can stream assets and/or scene data, receive input from, and/or transmit commands to one or more universal hosts. Similarly, a universal host can be connected and interact with one or more universal servers.

In some embodiments, the universal server and host system 200 enables a scene to be viewed simultaneously from multiple perspectives-enabling not just multiple users, but multiple views (e.g., cameras, volumes) per user. In 3D space, some visuals are view-dependent. Such visuals include, for example, graphical effects such as global illumination and/or lighting, text orientation (e.g., often towards users so that it always faces each viewpoint), and so forth. Furthermore, performance optimization techniques such as culling may explicitly simulate and/or rendering what is in view. The universal server and host system 200 can ensure one or more of hosts 204, 206 and so forth (e.g., via their local simulations) maintain a local virtual scene graph including everything replicated from the application simulation (e.g., from the universal server 202). Each view (e.g., corresponding to each 2D camera or 3D volume camera) replicates a local partial scene graph containing view-specific backing objects that correspond to objects visible from the corresponding camera's perspective—for example, culled objects are excluded. The partial scene graph encodes viewpoint-specific effects, such as geometry oriented toward the respective view point, particles baked to a mesh corresponding to said viewpoint, global illumination (GI) calculated in respective view's screen space, and so forth. Ensuring each host has a local virtual scene graph corresponding to a complete copy of the world thus enables view-dependent capabilities, and/or reduces bandwidth—for example, the universal server and host system 200 can send only change deltas from a host to each sim. Furthermore, the universal server and host system 200 can spawn new views quickly, and/or change viewpoint rapidly. Additionally, the universal server and host system 200 can control the overhead imposed on the host or backend by limiting the set of concrete backing objects per view (e.g., using a predetermined maximum).

The asset and/or update streaming capability that allows the universal server 202 to stream required assets and/or updates to one or more hosts (e.g., 204, 206, etc.) is a defining feature of the architecture. Hosts do not require pre-existent data or logic specific to an application (e.g., an application adhering to a universal server specification), thereby acting as ‘universal’ hosts. Furthermore, the universal server and host system 200 can enable the transmission of command streams and/or scene graph or scene representations of different levels of granularity (e.g., high-level representations or low-level representations, etc.), as discussed below.

The example embodiments described above refer to a high-level representation of commands and/or scene representations. However, a renderer (e.g., a Unity renderer, etc.) and/or other simulation running at a host can convert such a high-level representation to a low-level representation. Such a conversion can, in some embodiments, correspond to a compression scheme that uses the higher-level semantics of data (e.g., Unity components, component properties, etc.) for network transmission, as further described below. In some embodiments, low-level representations include low-level commands and/or low-level assets. Low-level commands are similar to graphics APIs DirectX 12, Vulkan or Metal, but belong to a cross-platform dialect. Such low-level commands can be converted to API calls on device (e.g., setting pipeline state, issuing a draw call, etc.). Low-level assets are similar to graphics assets: vertex/index/constant buffers, shader byte code, shader resources (SRVs, UAVs), textures, pipeline state (PSOs), and so forth. In some embodiments, Unity (e.g., a Unity simulation) converts its high-level commands to corresponding low-level commands. In some embodiments, Unreal converts its high-level commands to cross-platform low-level command that can run on one or more additional engines, and support less stateful content and/or features (e.g., VFXGraph or the functionality of Unity's SRPs).

High-level representations can be preferable for network transmission, while in some embodiments, a sufficiently expressive set of low-level representations can be preferable for third parties and/or platform implementers. Such actors would need to only implement a small command set closely corresponding GPU hardware, not a rich command set requiring a full-fledged engine, as further detailed below.

In some embodiments, the universal server and host system 200 uses high-level commands and/or assets for transmitting and/or sync-ing scenes over the network, the high-level representations helping to reduce bandwidth, while employing low-level representations as fallback. For example, a remote host reconstructs the scene from the high level data (e.g., in Unity), and then converts the scene to low-level commands consumed by the local backend. Converting to low-level commands instead of directly mapping to GPU calls enables incorporating a Unity-specific backend, and/or a different backend specified by a platform owner and/or third-party, without the need to implement a corresponding full API spec. The use of intermediate low-level commands instead of GPU calls mean the commands can be directed to a Unity-based renderer, or to a third-party backend supporting only the low-level commands that closely match the GPU and are therefore easier to implement than the full API spec. For example, in the case of a particle system, a universal server application (e.g., Unity sim) can transmit high-level particle data (e.g., particle component properties) to a remote host. The remote host's (Unity) local simulation can reconstruct the scene locally from the high-level particle data. The remote host's (Unity) local simulation can convert the particle system to low-level commands and/or assets. This operation includes, for example, simulating the particle system and/or baking out view- and time-dependent vertex buffers, index buffers, and/or material properties.

Streaming assets from universal server to universal host eliminates app-specific data requirements for the host. Required content is provided by the universal server (or a proxy such as a CDN) as needed. A universal server and host system includes one or more optimizations related to streaming assets from a universal server to a universal host, as described below.

In some embodiments, the universal server 202 replicating its scene on connected universal hosts enables superior responsiveness needed for interactive content through allowing for generalized interpolation which leads to reduced update rates, extrapolation (e.g., predicting future actions and covering latency at the host level) or local preview corresponding to a more responsive user interface (UI). The universal server 202 streaming assets necessary for scene construction has the effect of front loading the bandwidth requirements and therefore reducing the bandwidth requirements at runtime.

In some embodiments, the universal host can cache assets locally for improved performance. Caching on the host will enable high-quality (high-resolution) versions of frequently and recently used content be available to run immediately. In some embodiments, assets can be progressively sent from the server to the host. For example, a game requires several hundred 1024×1024 textures, but these are not sent right away. Instead, the server sends lower resolution (and therefore lower size) representations on the first frame (e.g., lower resolution mipmaps), and then streams higher resolution versions over time. This feature allows the system to amortize asset loading costs, while showing a subset of the assets right away and then improving the display by integrating higher resolution versions over time. In some embodiments, assets are sent based on criteria including whether the assets are required for a current scene, their apparent size (in screen space), and/or are currently visible. In contrast, game installs can require downloading or copying all data for every scene before the game can start. In some embodiments, the system uses a triage-based scheduling system which takes into account the priority levels for specific updates, which can depend on the magnitude or importance of a change or update. High-priority updates are sent at interactive rates, while lower-priority or small-delta updates (updates corresponding to minor changes, and so forth) are dispatched less frequently.

In some embodiments, the universal server and host system 200 enables a decoupling of the simulation frame rate from the render frame rate. The universal server and host system 200 can use local simulation interpolation/extrapolation/rollback capabilities at hosts to predict server commands before they are received. This capability reduces bandwidth and improves responsiveness, especially on platforms particularly sensitive to visual latency, such as HMDs.

In some embodiments, delta compression and other industry standard optimization techniques are leveraged to reduce network bandwidth requirements. In some embodiments, a content distribution network (CDN) is used to distribute this asynchronously from the game connection, which also mitigates latency and bandwidth issues.

In some embodiments, the universal server and host system 200 includes multispatial (or polyspatial) graph capabilities, corresponding to support for complex application topologies. For example, a universal server and host system with multispatial graph support can allow for arbitrarily deep nesting of applications, where applications function as hosts for other applications. In some embodiments, the universal server and host system 200 with additional multigraph support enables running a first game with interactive elements as a demo within an advertisement running in a second game. In some embodiments, the first game is fully interactive, and the demo is fully playable, thereby rendering the advertisement fully playable as well. In some embodiments, the universal server and host system 200 can enable XR users to see the active applications of nearby XR users without an additional installation step. In some embodiments, an AR user can see another AR user's virtual costumes or pets, or join ad-hoc gaming interactions. In some embodiments, a universal server and host system 200 can be used to enable a user to purchase a game plugin (a chat tool, avatar system, in-game HUD) once and run it in any of a multiple games (such as for example, a Unity game) without an installation step. In some embodiments, the universal server and host system 200 can be used to deploy a generalized framework for recording and playing back a game session (such as a Unity game session).

In some embodiments, the universal server and host system 200 can be used to implement an experience where users swipe through and/or interact with presented games, videos and/or advertisement (e.g., included in one or more feeds), where each game corresponds to a new universal host instance connected to a universal server supplying the games. In some embodiments, videos (or other media content), as well as advertisements, could be similarly associated with host instances for video playing applications and/or ad playing applications connected to one or more universal servers supplying media and/or advertising experiences. In some embodiments, the universal server and host system 200 can enable users to swipe through content sequentially, with the content being represented by a mix of playable demos, mini games, ads, videos, and/or premium games. In some example, this mix of content can be available within a single universal app whose content and/or experiences are hosted remotely (e.g., on a server, in the cloud). Each piece of content (e.g., a playable game, an ad, a video) can be associated with its own universal host instance (e.g., its own polyspatial host), transiently spawned upon detecting that a user has engaged with the specific content. The host instance can be connected to a corresponding persistent server that streams the content and/or runs the simulation associated with the playable content. Associated each piece of content with its own host and/or controlling the order and/or mix of the content presented to the users enables the universal server and host system 200 to make up for the latency of choice expensive streaming content by spinning up a corresponding host for such expensive content (e.g., in the background) to start preloading assets and/or content, while displaying less expensive content in the interim (e.g., videos, ads, simpler games, each associated with its own host instance).

In some embodiments, developers can leverage the system's built-in client-server architecture to implement networking with minimal effort for a wide class of problems. By having the core application logic run on the universal server 202, the universal server and host system 200 transforms the hard problem of multi-user network programming into the much simpler problem of implementing local multi-user support (“couch co-op” support).

FIG. 3 is a diagrammatic representation 300 of an application architecture, according to some embodiments. In some embodiments, the architecture is a local architecture. In some embodiments, the application (e.g., a Universal Server-Host App) refers to a Unity game or application (as indicated above, a game or application created using the Unity Editor™ and/or including Unity Technologies' real-time engine runtime application or parts thereof). In some embodiments, the application refers to a program that implements a universal server specification. In some embodiments, the application implements a universal host specification.

In some embodiments, the application processes received input, updates its internal state, runs app-specific simulation, and/or tracks and/or serializes changes to its output state as a result of received and processed input and/or the passage of time. Changes are encoded as commands, such as scene graph commands, lifecycle commands, input commands, low-level graphics commands, and so forth. Lifecycle commands include commands such as “Begin/EndSession,” “Begin/EndConnection,” “Begin/EndFrame.” Input commands can include simple input commands such as mouse clicks, pointer movement (2D or 3D), button presses (keyboard or controller), sticks (game controller). Input commands can also refer to more complex input sources, corresponding to head and joint transforms, AR planes, AR tracked images, AR Meshing, and so forth. Scene graph commands can include asset updates, component updates, and so forth.

Assets include meshes, materials, textures, shader and/or animation rig information, fonts, audio clips, low level GPU assets (e.g., including textures, buffers, pipeline state), and so forth. Examples of assets can be found in the “ASSETS” section of the GLOSSARY.

Component updates include transform updates, material property changes, collision and motion state associated with graphical content and so forth. In some embodiments, the determined changes (e.g., scene graph commands) are handled by platforms that run on a specific local device or in editor.

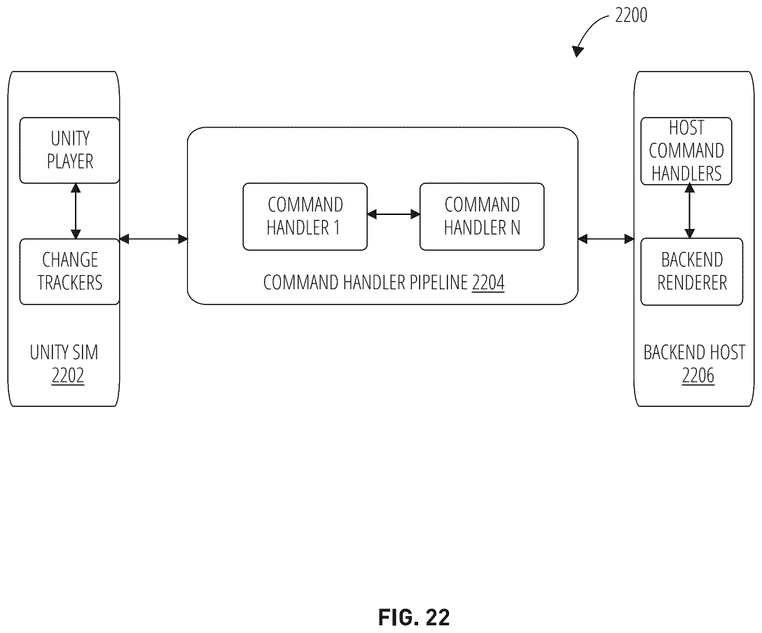

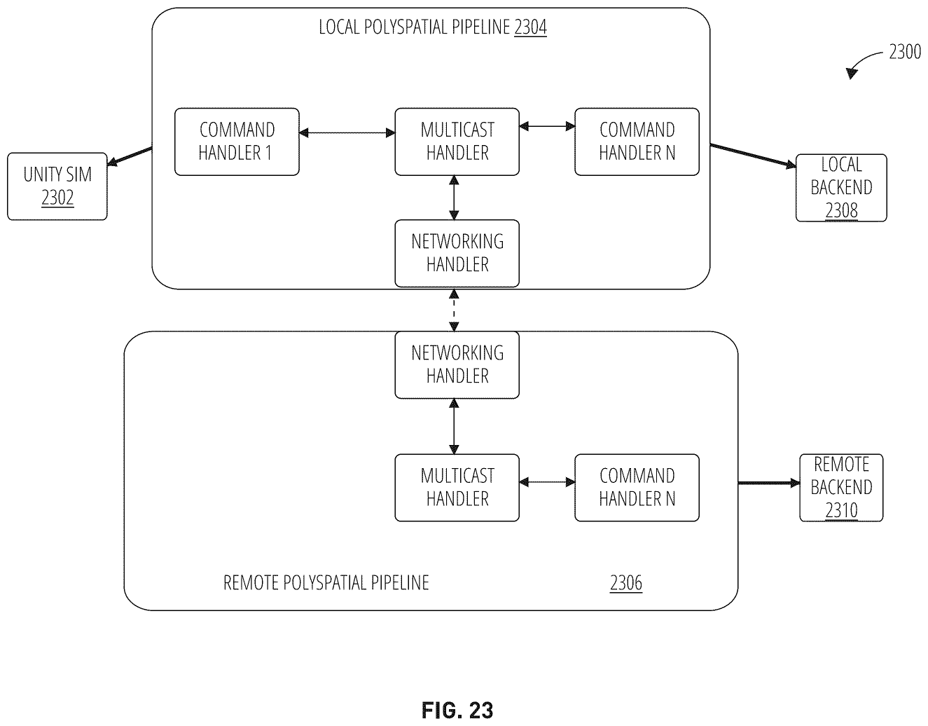

In some embodiments, the application (e.g., Universal Server Host App) integrates with a platform (e.g., UniversalServerHostPlatform) that can run on device or in editor, in play mode or in edit mode. UniversalServerHostPlatform examples include UnityEditorPlatform, a UnityPlayerPlatform, a UnityShellPlatform, a Unity UniversalServerHostNativePlatform, and so forth. A UniversalServerHostPlatform can back or integrate representations (e.g., command representations, scene representations), for example by integrating updates to assets or components into a native scene graph (e.g., collision information can be added into a scene graph with respect to relevant game objects). Alternative asset and/or command transmission mechanisms (both local and over the network) are described at least in FIG. 22 and FIG. 23.

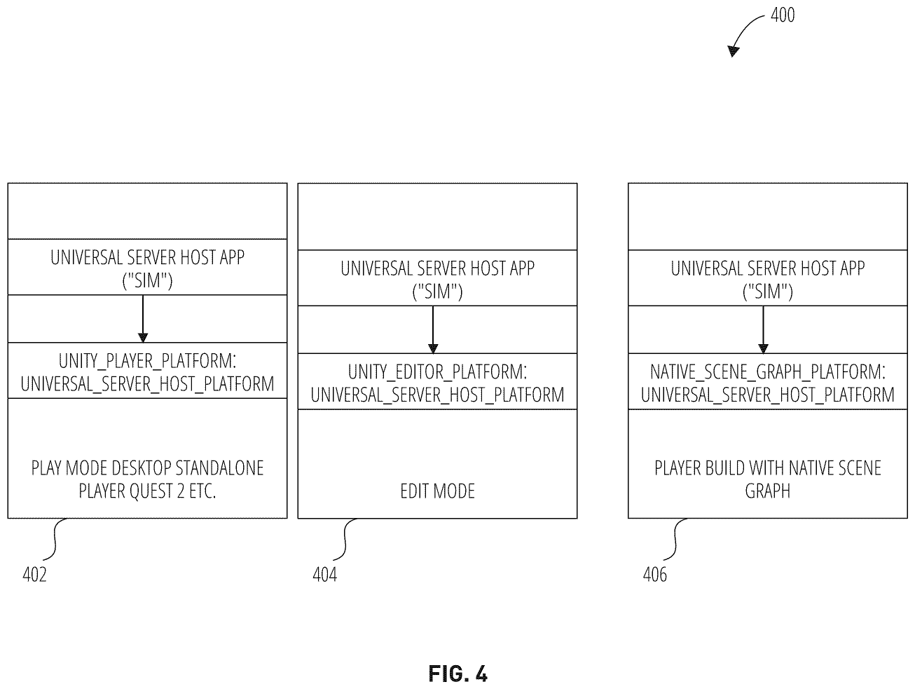

FIG. 4 is a diagrammatic representation 400 of views 402, 404, and 406 of a universal server and host system 200, according to some embodiments. In some embodiments, elements 402, 404 and/or 406 refer to local examples of applications. In some embodiments, element 402 refers to an app such as a Unity game, Unity application, or other software such as software outside of the Unity platform. In some embodiments, element 402 refers to a standalone app in play mode (e.g., a desktop standalone app). In some embodiments, element 404 refers to a standalone application in edit mode. In some embodiments, element 406 refers to an app in player build mode.

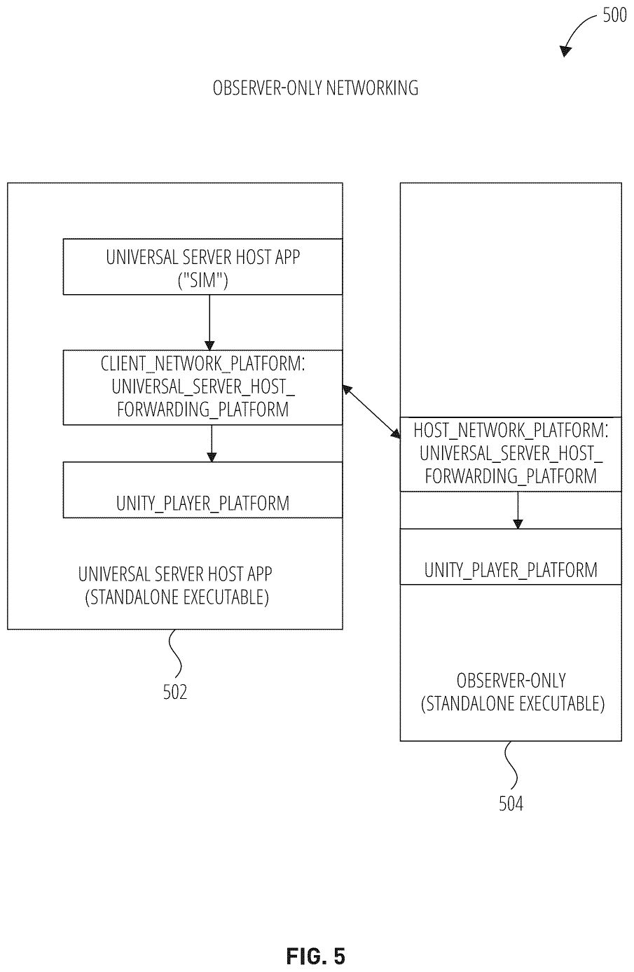

FIG. 5 is a diagrammatic representation 500 of a view of a universal server and host system 200, according to some embodiments. In some embodiments, an application 502 adhering to the universal server specification (e.g., a Universal Server-Host App corresponding to a Unity application or game) can communicate with an observer-only application 504 that adheres to the universal host specification. In some embodiments, a universal server and host system 200 could therefore enable experiences such as streaming live play on Twitch or a similar platform by providing built-in facilities for “observer-only” clients for games.

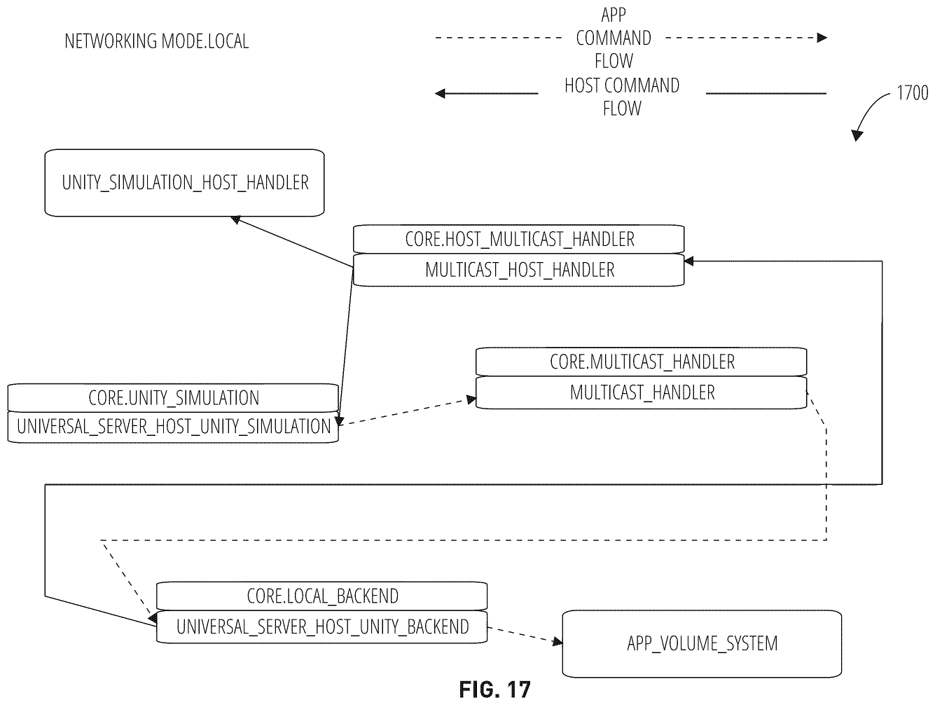

In some embodiments, the communication between the application adhering to the universal server specification and the application adhering to the universal host specification is achieved using a ClientNetworkPlatform and a HostNetworkPlatform. In some embodiments, a ClientNetworkPlatform can run on device or in editor. Similarly, a HostNetworkPlatform runs in editor or on device. A ClientNetworkPlatform enables backed render components and colliders to sync over a socket (e.g., see the data flow interaction depicted in FIG. 5, and further exemplified in FIG. 17 to FIG. 21). In some embodiments, a HostNetworkPlatform carries an instance of a UnityPlayerPlatform, or a UnityServerHostNativePlatform to forward. Alternative communication mechanisms are described at least in FIG. 22 and FIG. 23.

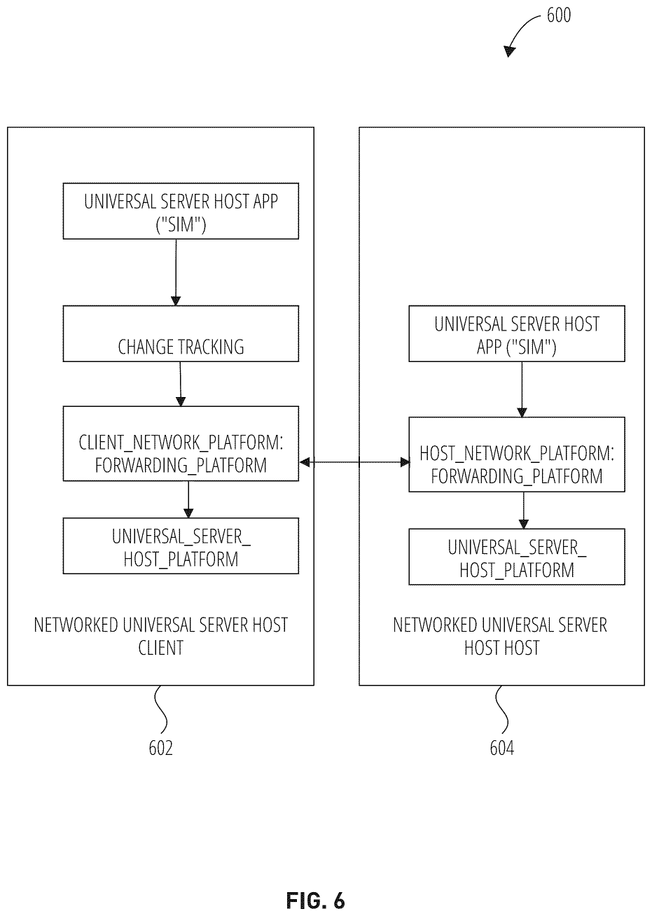

FIG. 6 is a diagrammatic representation 600 of a view of universal server and host system 200, according to some embodiments. In some embodiments, a client application 602 (e.g., a Unity game or application) adhering to the universal server specification (see, e.g, FIG. 2) is connected to a host application 604 implementing a universal host specification. In some embodiments, the host application is a shell application. As detailed in FIG. 2, the application implementing the universal server specification updates its internal state, runs app-specific simulation, serializes any changes to its output state as a result of the passage of time as well as any received and processed input (e.g., from one or more connected hosts), and/or encodes any changes as scene graph commands. In some embodiments, the output in the form of scene graph commands is sent to one or more connected hosts (here, to the shell application implementing the universal host specification). In some embodiments, scene graph commands include asset updates and/or component updates. In some embodiments, the application structure, assets and components are similar to those described for the application example in FIG. 3.

In some embodiments, the communication or data flow between a networked client (e.g., an app implementing the universal server specification) and a networked host (e.g, implementing the universal host specification) relies on platforms (e.g., a ClientNetworkPlatform and HostNetworkPlatform) that run either in editor or on device. In some embodiments, as part of a networked data flow (for example, involving a client network platform and a host network platform, and illustrated in more detail in at least FIG. 17-FIG. 21), backed render components and colliders are synced over a socket. Alternative communication mechanisms are described at least in FIG. 22 and FIG. 23.

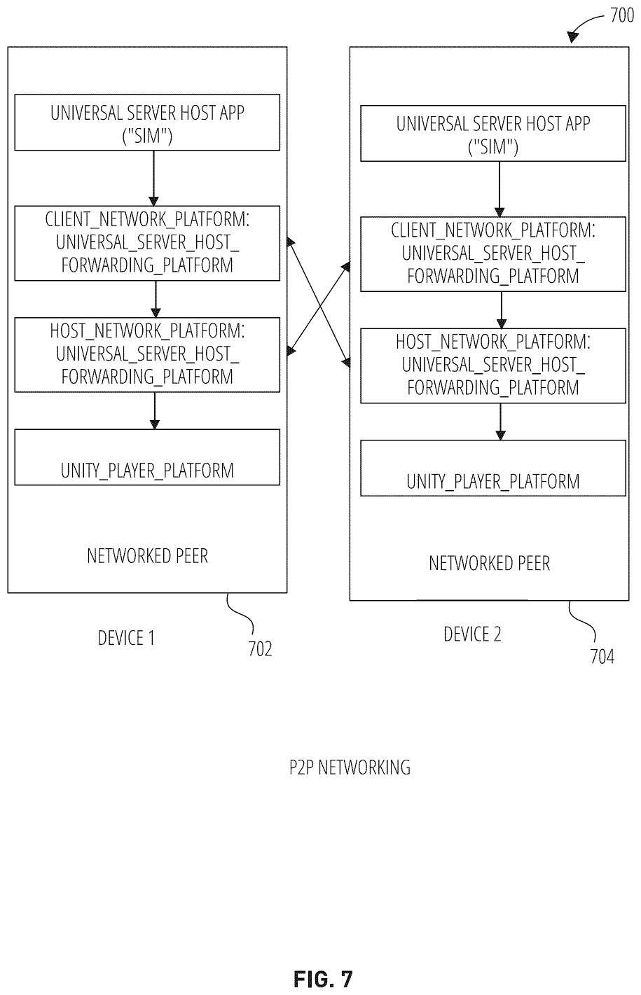

FIG. 7 is a diagrammatic representation 700 of a view of a universal server and host system 200, according to some embodiments. In some embodiments, instances of applications implementing the universal server specification can run on different devices (see, e.g., 702 and 704). The instances can correspond to the same application. In some embodiments, as detailed above in FIG. 2, the applications can also be hosts. In some embodiments, the universal server and host system 200 enables peer-to-peer (P2P) networking involving such application instances. The universal server and host system 200 can use application-host communication (e.g., networked) between a ClientNetworkPlatform and a HostNetworkPlatform (see, e.g., FIG. 17-FIG. 20 for examples of data flow topologies and implementations). Alternative communication mechanisms are described at least in FIG. 22 and FIG. 23.

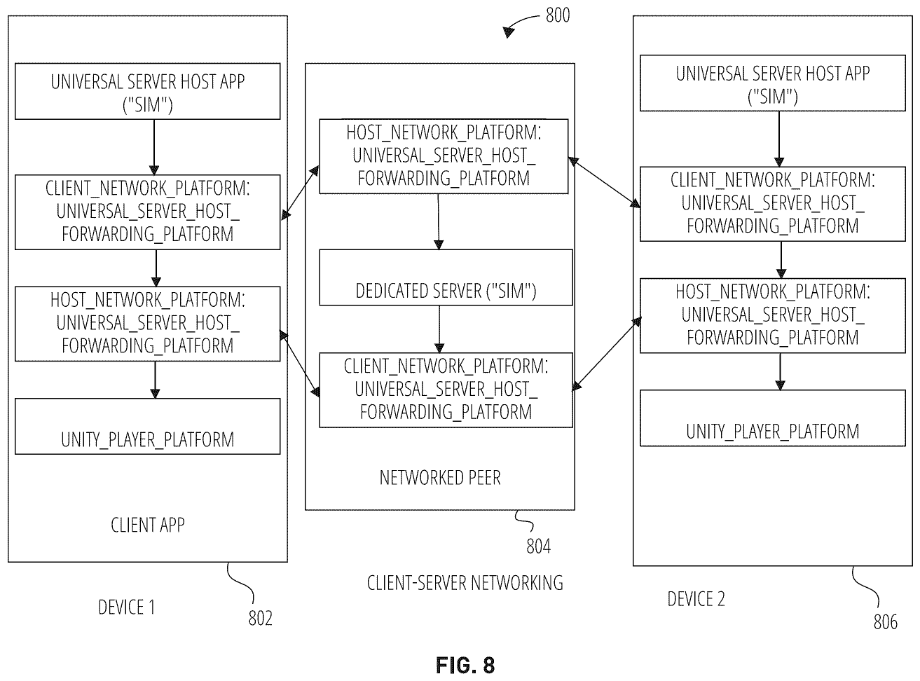

FIG. 8 is a diagrammatic representation 800 of a view of a universal server and host system 200, according to some embodiments. As described in FIG. 2, core application logic can be provided by a dedicated server (an authoritative server, see e.g., 804) adhering to a universal server specification, while one or more universal hosts on one or more devices can function as standalone applications that connect to, display or interact with applications that adhere to the universal server specification. For example, a first instance of an application (e.g., Universal Server-Host app, representing for example a Unity application or game) runs on a first device (Device 1, as seen, e.g., in 802), while a second instance of an application runs on a second device (Device 2, as seen, e.g., in 806). In some embodiments, the application running on the second device is the same as on the first device. In some embodiments, the client applications use a “universal player” platform (e.g., UnityPlayerPlatform) that runs in play mode and backs render components in an additive scene graph.

In some embodiments, the communication flow between an application and a host relies on forwarding platforms (e.g., a ClientNetworkPlatform, a HostNetworkPlatform) that run either in editor or on device. In some embodiments, backed render components and/or colliders are synced over a socket as part of a networked data flow (e.g., involving a client network platform and a host network platform, and illustrated in more detail in at least FIG. 17-FIG. 21). In some embodiments, a host network platform is associated with a platform instance or backend (e.g., a “universal player” platform such as UnityPlayerPlatform) to forward. Alternative communication mechanisms are described at least in FIG. 22 and FIG. 23.

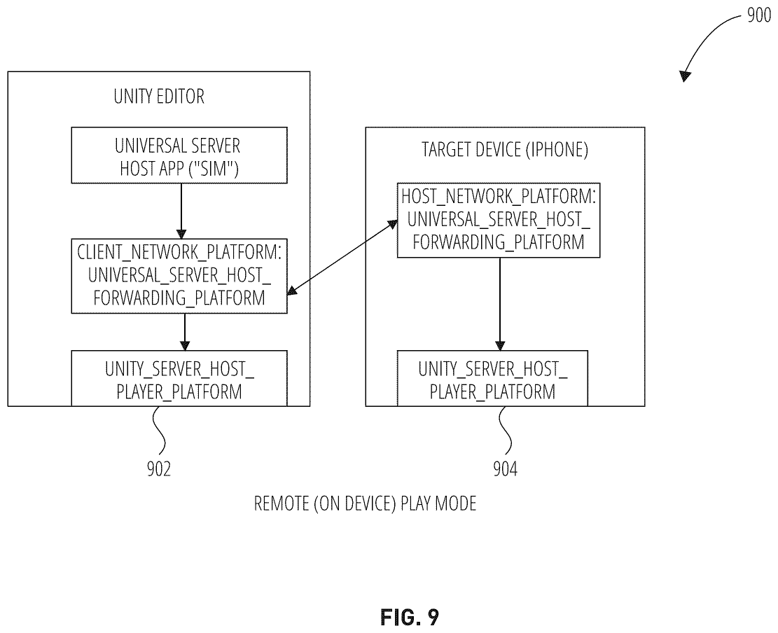

FIG. 9 is a diagrammatic representation 900 of a view of a universal server and host system 200, according to some embodiments. FIG. 9 illustrates an application 902 running in editor that implements the universal server specification (e.g., an app such as a Unity game or application) and interacts with a host application 904 on a target device (e.g., an iPhone). In some embodiments, the target device host is associated with a “universal player” platform (e.g., UnityPlayerPlatform); for example, once a universal player has been installed on the target device and can communicate with a universal server-adhering application, (such as the above-mentioned app), a user of the device can remotely play any such compatible application.

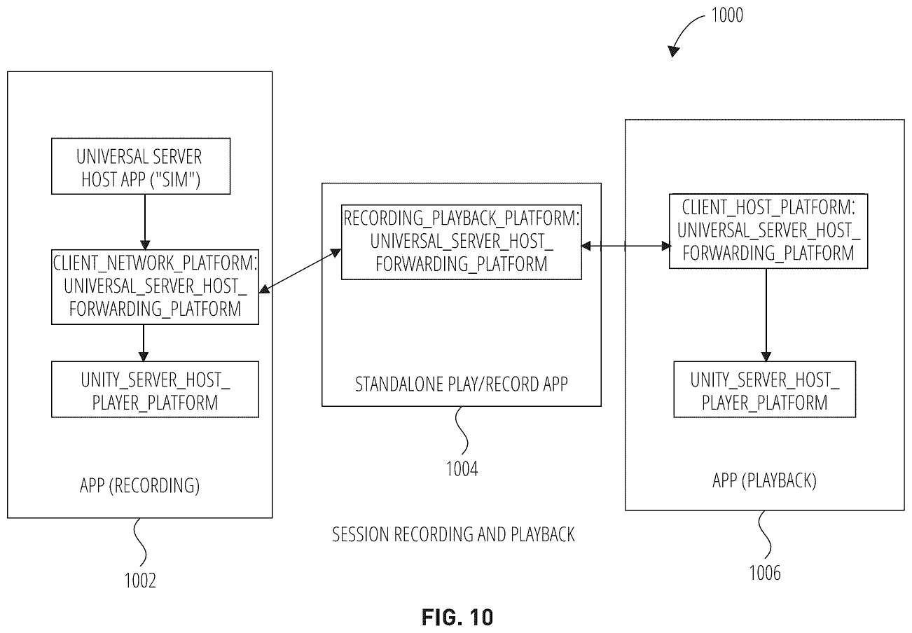

FIG. 10 is a diagrammatic representation 1000 of a view of a universal server and host system 200, according to some embodiments. FIG. 10 illustrates an example implementation of a session recording and playback capability for a game session (such as a Unity game session). In some embodiments, a standalone play/record application 1004 operates as a host for a recording application 1002 and a playback application 1006.

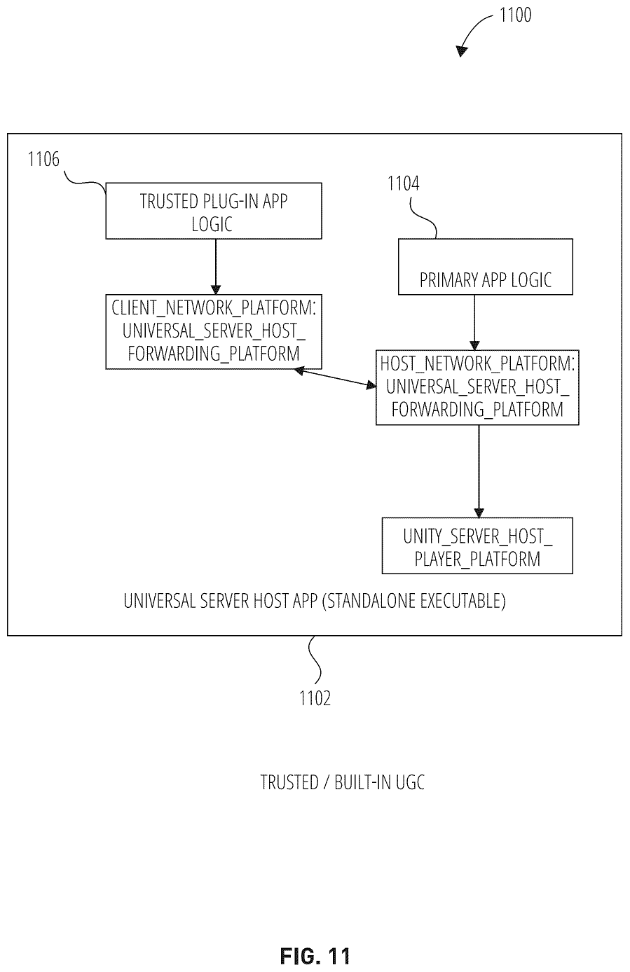

FIG. 11 is a diagrammatic representation 1100 of a view of a universal server and host system 200, according to some embodiments. In some embodiments, the universal server and host system 200 further includes multispatial (or polyspatial) graph capabilities, allowing for arbitrarily deep nesting of applications. In this example, a primary app with primary app logic 1104 operates as a host app for a plugin app (here, a trusted or built-in plugin) with corresponding internal plugin app logic 1106. The universal server and host system 200 enables fully featured, sandboxed plugins, such as for example user-generated content (UGC), that can run within other applications. In some embodiments, such full-feature plugins include chat apps, streaming tools, minigames, fully-playable ads, achievement systems, and so forth. Such plugins can enable interactive or fully playable ads (or demos), which can increase engagement and help differentiate in-game ads from more static media, such as video, image, or text-based ads. Such plugins could be dramatically useful in increasing ad market reach (e.g., for Unity ads).

Plugins can run within other applications, such as the standalone executable 1102 (with primary app logic 1104). Such container or host applications can include social VR applications (VR Chat, Recroom, Altspace, etc.), which provide ways for users to develop custom content, but must mitigate issues such as version mismatching or security concerns. Sandboxing applications in their own process (while enabling them to connect, for example via local sockets) delegates responsibilities like system source management and security to the underlying operating system (OS). Therefore, the universal server and host system 200 (in conjunction with multispatial graph capabilities) can provide a generalized framework for integrating user-generated content (UGC) that allows applications to support arbitrarily complex user-created content that is safe to run via OS-level sandboxing. Furthermore, the universal server and host system 200, in conjunction with multispatial graph capabilities, enables developing a game plugin once and running it within one or more applications (such as for example Unity games or other applications).

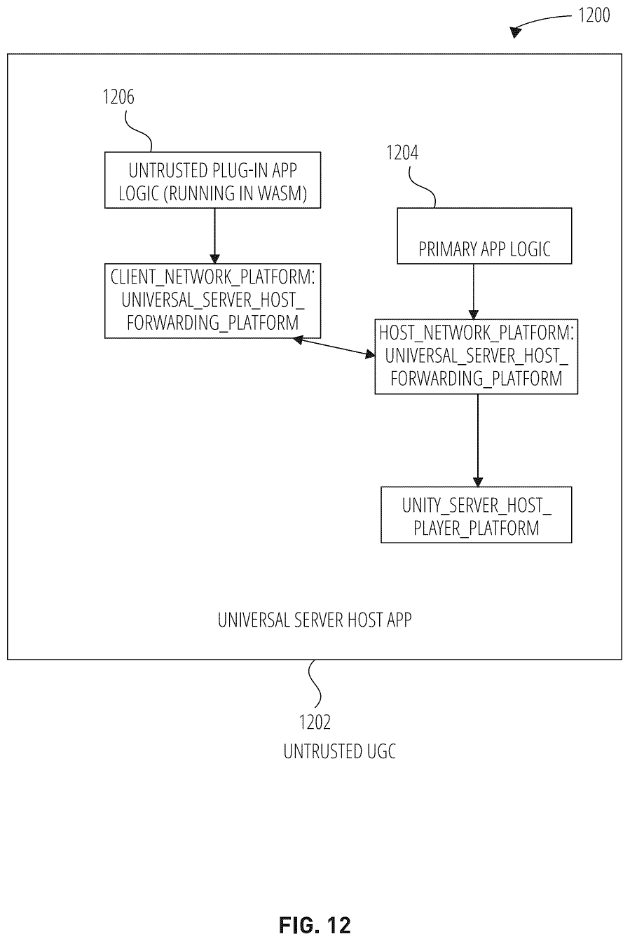

FIG. 12 is a diagrammatic representation 1200 of a view of a universal server and host system 200, according to some embodiments. In this example, a standalone or primary app 1202 with primary app logic 1204 operates as a host app for a plugin app (here, an untrusted plugin) with corresponding internal plugin app logic 1206. Such untrusted plugins can correspond to content generated by users that is not built-in to the primary app. In some embodiments, the untrusted plugin app is associated with a portable binary code format (e.g., Web Assembly (WASM), etc.). Sandboxing applications in their own process (while enabling them to connect, for example via local sockets) delegates responsibilities like system source management and security to the underlying operating system (OS), and allows the system to run user-created content in a safe manner.

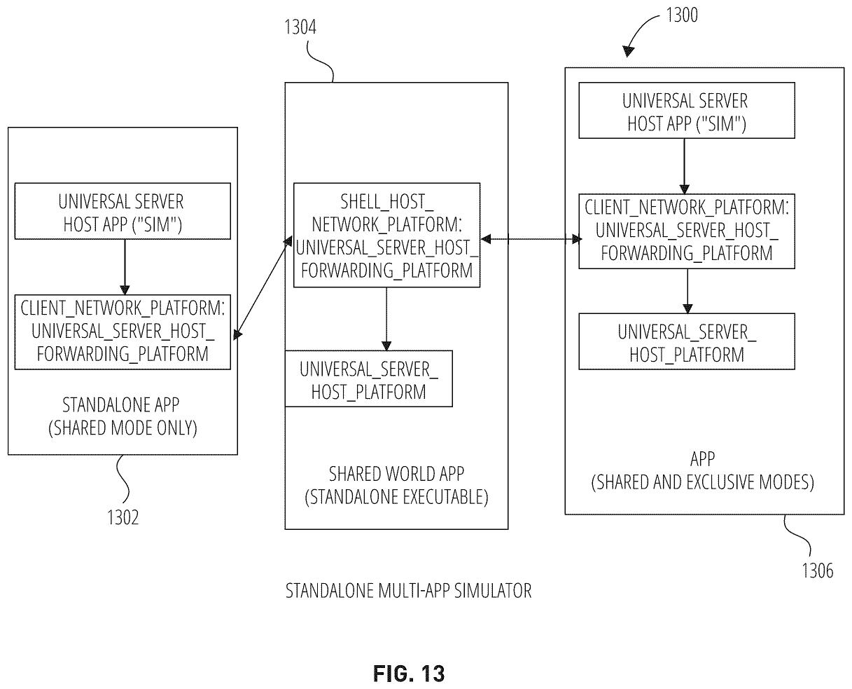

FIG. 13 is a diagrammatic representation 1300 of a view of a universal server and host system 200, according to some embodiments. In some embodiments, the universal server and host system 200 enables implementing a standalone multi-application simulator. For example, a shared world app 1304 can function as a host for a first app 1302 (e.g., a standalone Universal Server-Host App in shared mode) and a second app 1306 (e.g., a Universal Server-Host App in shared and/or exclusive modes).

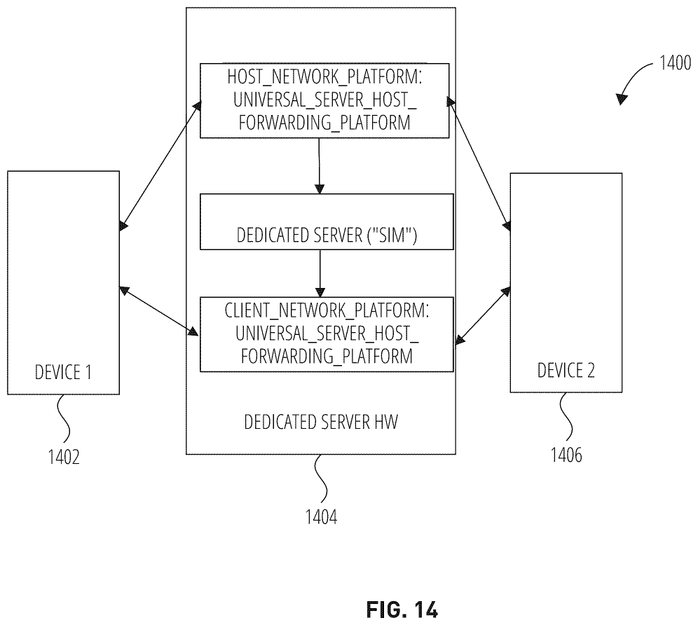

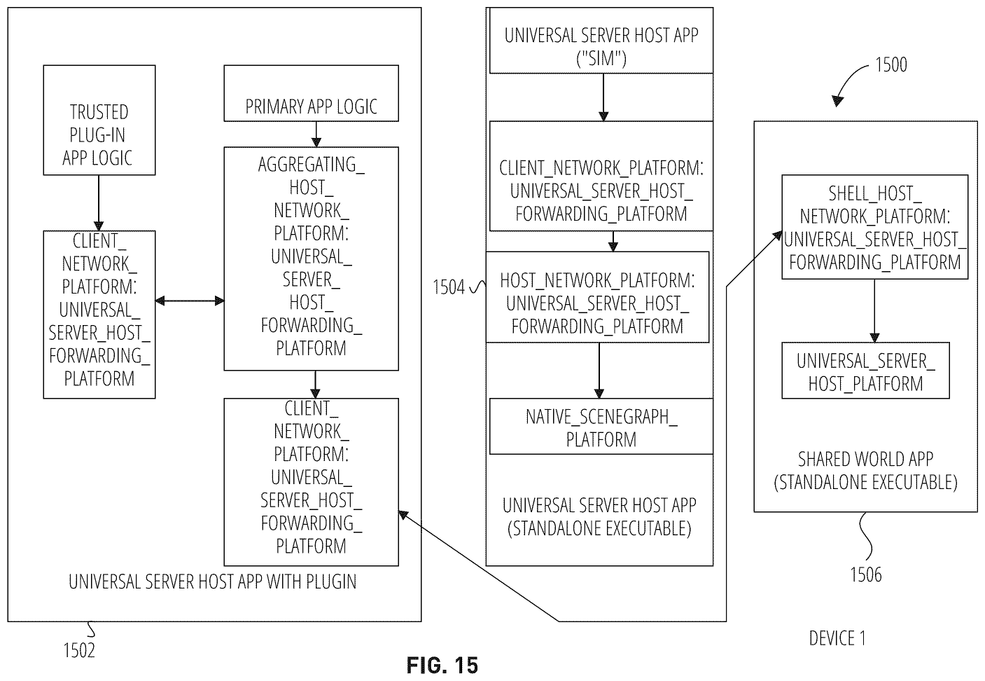

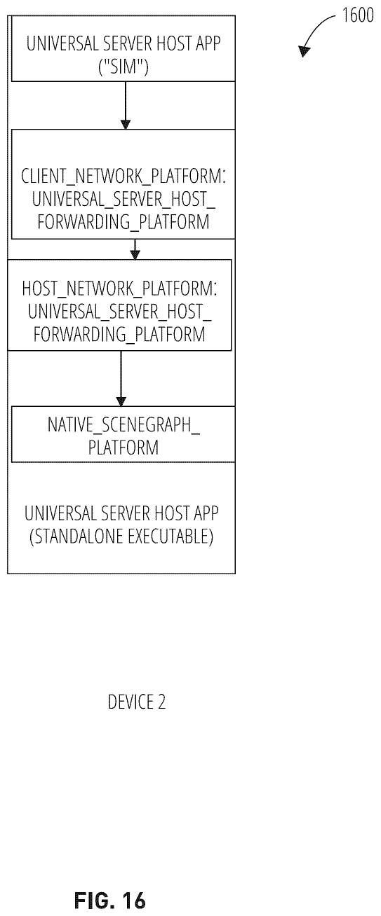

FIG. 14 is a diagrammatic representation 1400 of a view of a universal server and host system 200, according to some embodiments. As previously indicated, the universal server and host system 200, in conjunction with a multispatial (or polyspatial) graph capability, enables software programs to become software platforms that host other applications in a recursive manner. As seen at least in FIG. 11 and FIG. 12, an application can host third party plugins. FIG. 14 illustrates a networked setup involving multiple applications on multiple devices (e.g., see details about Device 1 1402, Device 2 1406 in FIG. 15 and FIG. 16) and a dedicated server (see, e.g., 1404).

FIG. 15 is a diagrammatic representation 1500 of a view of a universal server and host system 200, according to some embodiments. In some embodiments, the universal server and host system 200, in conjunction with a multispatial (or polyspatial) graph capability, enables software programs to become software platforms that host other applications in a recursive manner. As seen at least in FIG. 11 and FIG. 12, an application can host third party plugins. FIG. 15 showcases a first device (Device 1) with corresponding applications 1502, 1504 and 1506, the first application 1502 hosting a third party trusted plugin application. In some embodiments, the first application 1502 itself can be hosted within a shared world shell 1506 (e.g, Shared World App). The shared world shell allows for simultaneous interaction of multiple applications (e.g., Universal Server-Host App with Plugin, Universal Server-Host App on dedicated server, as seen in FIG. 14), as part of a networked setup involving multiple users and/or devices (e.g., see, e.g., FIG. 13, FIG. 14, and FIG. 15).

FIG. 16 is a diagrammatic representation 1600 of a view of a universal server and host system 200, according to some embodiments. FIG. 16 illustrates a host application running on Device 2, the application being part of the networked setup described in FIG. 15 and FIG. 16.

FIG. 17 is a diagrammatic representation 1700 of a view of an application-host data flow in the context of a universal server and host system 200, according to some embodiments. In some embodiments, the application is a Unity game or application. In some embodiments, the host is a Unity game or application.

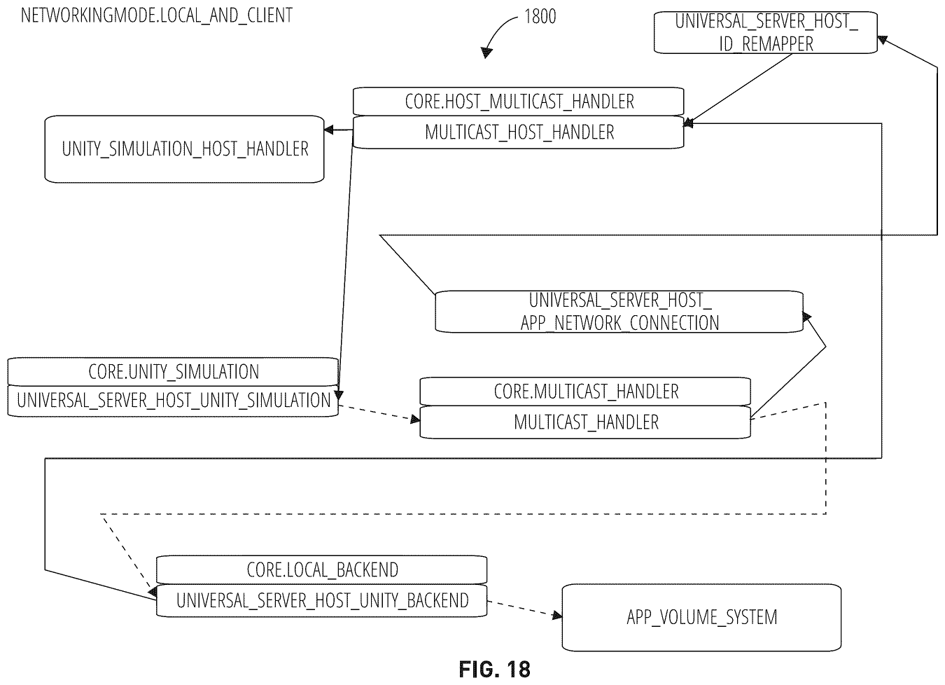

FIG. 18 is a diagrammatic representation 1800 of a view of an application-host data flow in the context of a universal server and host system 200, according to some embodiments. In some embodiments, the application is a Unity game or application. In some embodiments, the host is a Unity game or application.

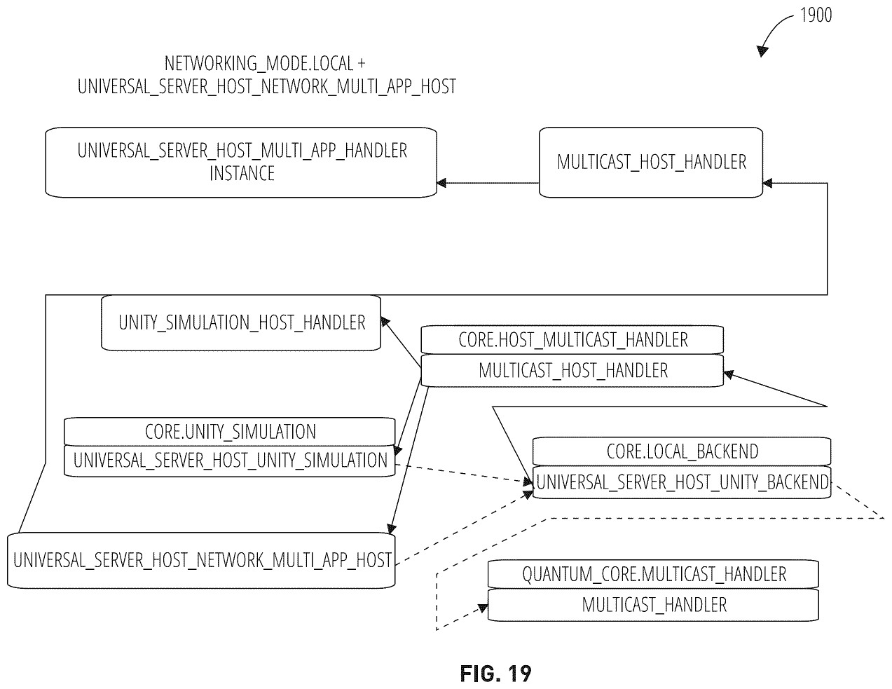

FIG. 19 is a diagrammatic representation 1900 of a view of an application-host data flow in the context of a universal server and host system 200, according to some embodiments. In some embodiments, the application is a Unity game or application. In some embodiments, the host is a Unity game or application.

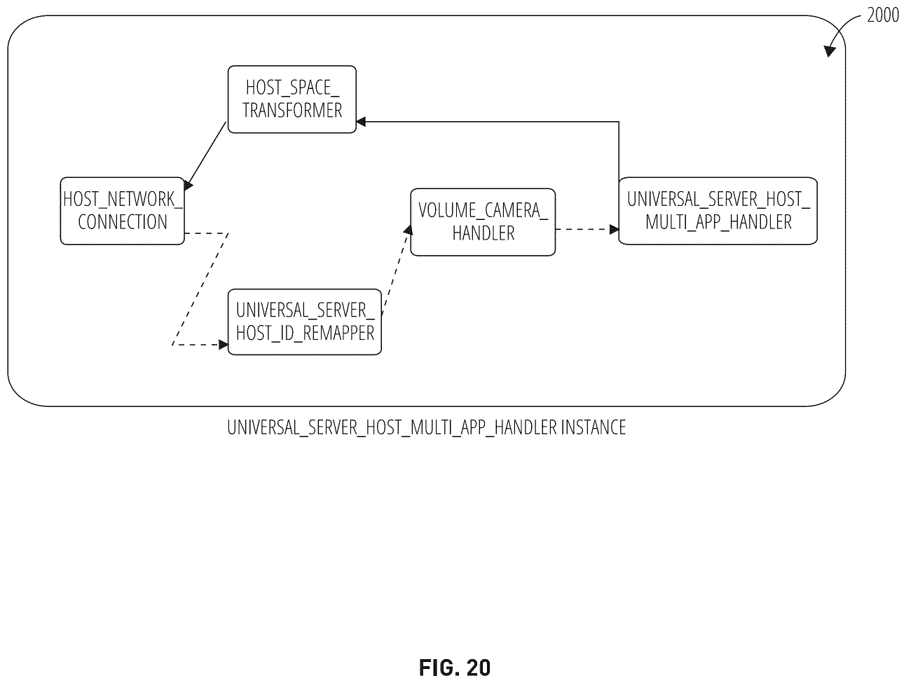

FIG. 20 is a diagrammatic representation 2000 of a view of an application-host data flow in the context of a universal server and host system 200, according to some embodiments. In some embodiments, the application is a Unity game or application. In some embodiments, the host is a Unity game or application.

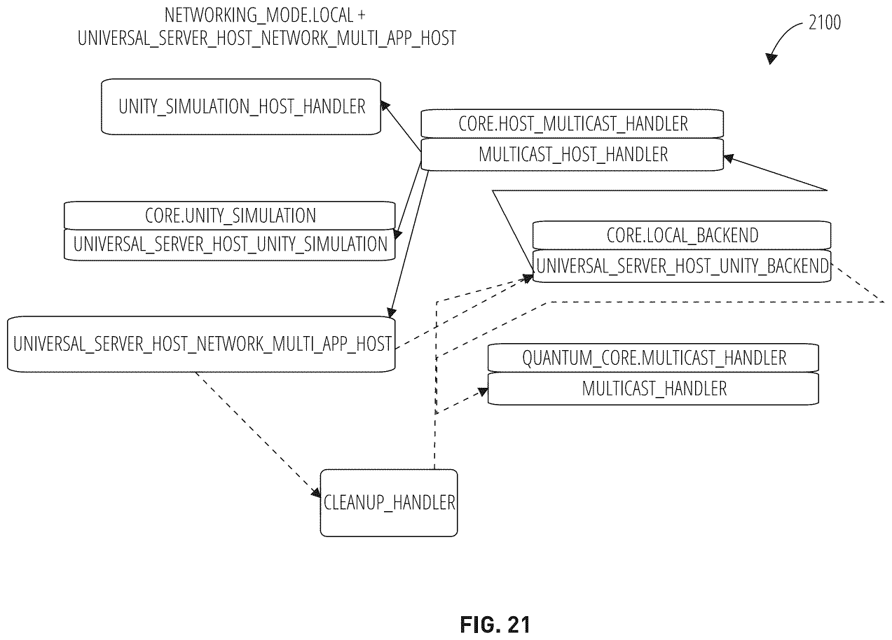

FIG. 21 is a diagrammatic representation 2100 of a view of an application-host data flow in the context of a universal server and host system 200, according to some embodiments. In some embodiments, the application is a Unity game or application. In some embodiments, the host is a Unity game or application.

FIG. 22 is a diagrammatic representation 2200 of a command pipeline as implemented by a universal server and host system 200. In some embodiments, the universal server and host system 200 uses CommandHandler operators to handle the processing and/or transmission of commands (e.g., scene graph commands, input commands, and so forth, as described at least in FIG. 2)—for example, FIG. 22 illustrates command handler pipeline 2204 connecting a Unity sim 2202 and a backend host 2206. In some embodiments, hosts and/or simulations (sims) are themselves command handlers as well. Thus, a host and/or a sim can be a terminal node and/or an intermediate node in an operator graph (further described below). The universal server and host system 200 thus allows for arbitrary chaining of hosts, simulations and/or intermediate command handler nodes, which leads to a flexible, extensible architecture.

Each CommandHandler is a self-contained operator that receives one or more change lists or commands, performs operations on the change lists or commands, and then forwards them to the next command handler. CommandHandler operators can be connected in stages and/or pipelines. In some embodiments, CommandHandler operators can be assembled into an arbitrary graph to perform complex operations.

An example CommandHandler can filter out commands, modify command data, inject new command, multiplex commands (e.g., branch data and/or send it to multiple receivers), remap IDs, append debugging information, perform compression/decompression, perform caching, transmit data, and so forth. Transmitting data can refer to sending in-memory data over the network via a socket, or receiving network data from a socket and convert to in-memory data (see, e.g., FIG. 23).

In some embodiments, the universal server and host system 200 uses an ICommandHandler interface and a IHostCommandHandler interface from which two endpoints can be derived. For example, the system can then derive PolySpatialUnitySimulation (e.g., similar in some respects to HostNetworkPlatform) and, respectively, PolySpatialNetworkSingleAppHost/PolySpatialNetworkMultiAppHost (e.g., similar in some respects to ClientNetworkPlatform). The universal server and host system 200 can accommodate an arbitrary graph of command handlers in between two endpoints to perform various operations. Thus, the system enables developers to build functionality in isolation, and/or provide a set of interacting (e.g., chained, etc.) operators assembled into complex graphs that perform complex operations.

FIG. 23 is a diagrammatic representation 2300 of a networked pipeline as implemented by a universal server and host system 200. In some embodiments, the universal server and host system 200 implements a networking solution that relies on individual CommandHandler operators. As mentioned in FIG. 22, CommandHandler operators can be connected in stages and/or pipelines—furthermore, pipelines can be connected over the network. Thus, CommandHandler operators can be chained, combined and/or assembled to perform complex operations. FIG. 23 illustrates local pipeline 2304 (e.g., a local polyspatial pipeline) and a remote pipeline 2306 (e.g., a remote polyspatial pipeline). FIG. 23 illustrates CommandHandler operators connected and/or chained, for example via multicast handlers and network handlers. The illustrated pipelines enable an application simulation (e.g, a Unity sim 2302) to communicate with a local backend 2308 and/or a remote backend 2310.

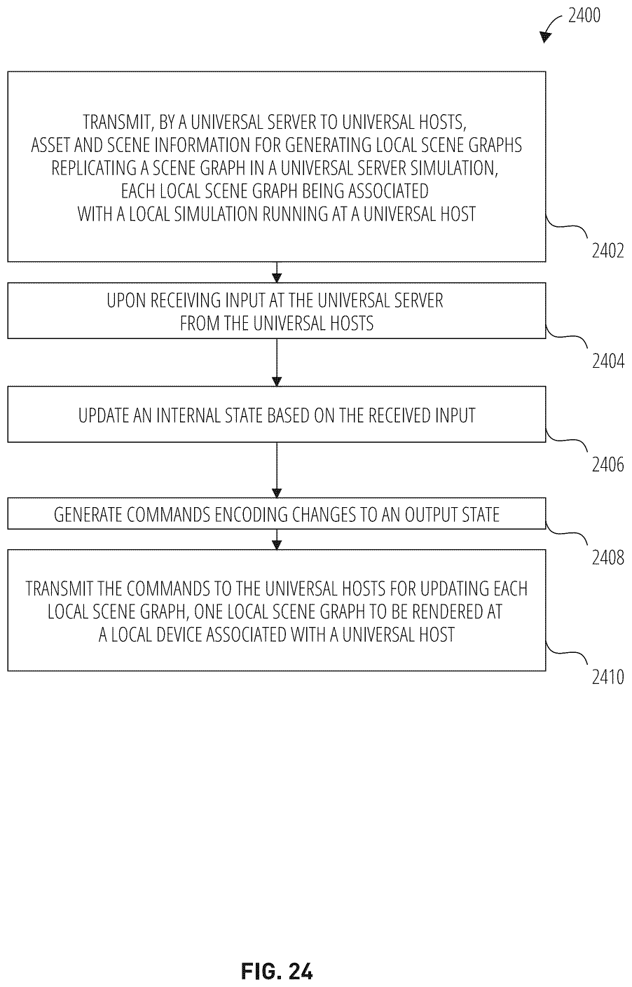

FIG. 24 is a flowchart illustrating a method as implemented by a universal server and host system 200, according to some embodiments. At operation 2402, the universal server and host system 200 transmits, to one or more universal hosts, asset and scene information to generate one or more local scene graphs, each local scene graph of the one or more local scene graphs replicating a scene graph associated with a simulation running at the universal server, each local scene graph of the one or more local scene graphs being associated with a respective local simulation running at a respective universal host of the one or more universal hosts. Upon receiving input from the one or more universal hosts (operation 2404), the universal server updates its internal state based on the received input (operation 2406), generates commands encoding changes to an output state (operation 2408), transmits the commands to the one or more universal hosts for updating each of the one or more local scene graphs at the respective universal hosts, at least one local scene graph of the one or more local scene graphs to be rendered at a local device associated with its respective universal host (operation 2410). In some embodiments, the universal server and the one or more universal hosts are applications.

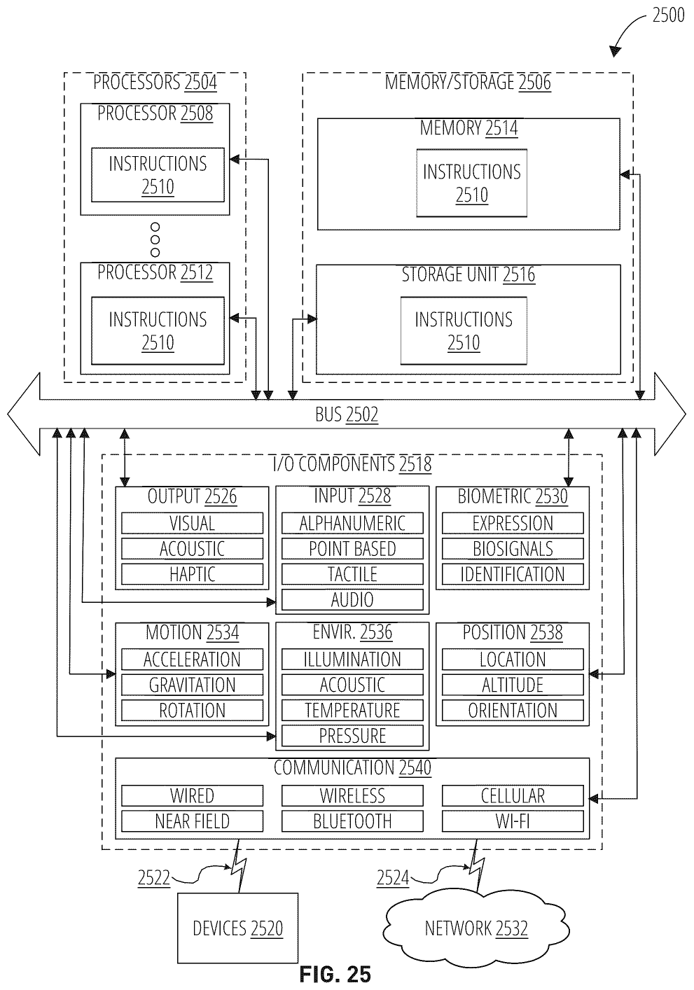

FIG. 25 is a block diagram illustrating components of a machine 2500, according to some example embodiments, able to read instructions from a machine-readable medium (e.g., a machine-readable storage medium) and perform any one or more of the methodologies discussed herein. Specifically, FIG. 25 shows a diagrammatic representation of the machine 2500 in the example form of a computer system, within which instructions 2510 (e.g., software, a program, an application, an applet, an app, or other executable code) for causing the machine 2500 to perform any one or more of the methodologies discussed herein may be executed. As such, the instructions 2510 may be used to implement modules or components described herein. The instructions 2510 transform the general, non-programmed machine 2500 into a particular machine 2500 to carry out the described and illustrated functions in the manner described. In alternative embodiments, the machine 2500 operates as a standalone device or may be coupled (e.g., networked) to other machines. In a networked deployment, the machine 2500 may operate in the capacity of a server machine or a client machine in a server-client network environment, or as a peer machine in a peer-to-peer (or distributed) network environment. The machine 2500 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 2510, sequentially or otherwise, that specify actions to be taken by machine 2500. Further, while only a single machine 2500 is illustrated, the term “machine” shall also be taken to include a collection of machines that individually or jointly execute the instructions 2510 to perform any one or more of the methodologies discussed herein.

The machine 2500 may include processors 2504, memory/storage 2506, and I/O components 2518, which may be configured to communicate with each other such as via a bus 2502. The memory/storage 2506 may include a memory 2514, such as a main memory, or other memory storage, and a storage unit 2516, both accessible to the processors 2504 such as via the bus 2502. The storage unit 2516 and memory 2514 store the instructions 2510 embodying any one or more of the methodologies or functions described herein. The instructions 2510 may also reside, completely or partially, within the memory 2514 within the storage unit 2516, within at least one of the processors 2504 (e.g., within the processor's cache memory), or any suitable combination thereof, during execution thereof by the machine 2500. Accordingly, the memory 2514 the storage unit 2516, and the memory of processors 2504 are examples of machine-readable media.

The I/O components 2518 may include a wide variety of components to receive input, provide output, produce output, transmit information, exchange information, capture measurements, and so on. The specific I/O components 2518 that are included in a particular machine 2500 will depend on the type of machine. For example, portable machines such as mobile phones will likely include a touch input device or other such input mechanisms, while a headless server machine will likely not include such a touch input device. It will be appreciated that the I/O components 2518 may include many other components that are not shown in FIG. 11. The I/O components 2518 are grouped according to functionality merely for simplifying the following discussion and the grouping is in no way limiting. In various example embodiments, the I/O components 2518 may include output components 2526 and input components 2528. The output components 2526 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2528 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 2518 may include biometric components 2530, motion components 2534, environmental environment components 2536, or position components 2538 among a wide array of other components. For example, the biometric components 2530 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2534 may include acceleration sensor components (e.g., accelerometer), gravitation sensor components, rotation sensor components (e.g., gyroscope), and so forth. The environment components 2536 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2538 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2518 may include communication components 2540 operable to couple the machine 2500 to a network 2532 or devices 2520 via coupling 2522 and coupling 2524 respectively. For example, the communication components 2540 may include a network interface component or other suitable device to interface with the network 2532. In further examples, communication components 2540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2520 may be another machine or any of a wide variety of peripheral devices (e.g., a peripheral device coupled via a Universal Serial Bus (USB)).

Moreover, the communication components 2540 may detect identifiers or include components operable to detect identifiers. For example, the communication components 2540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2540, such as, location via Internet Protocol (IP) geo-location, location via Wi-Fi® signal triangulation, location via detecting a NFC beacon signal that may indicate a particular location, and so forth.

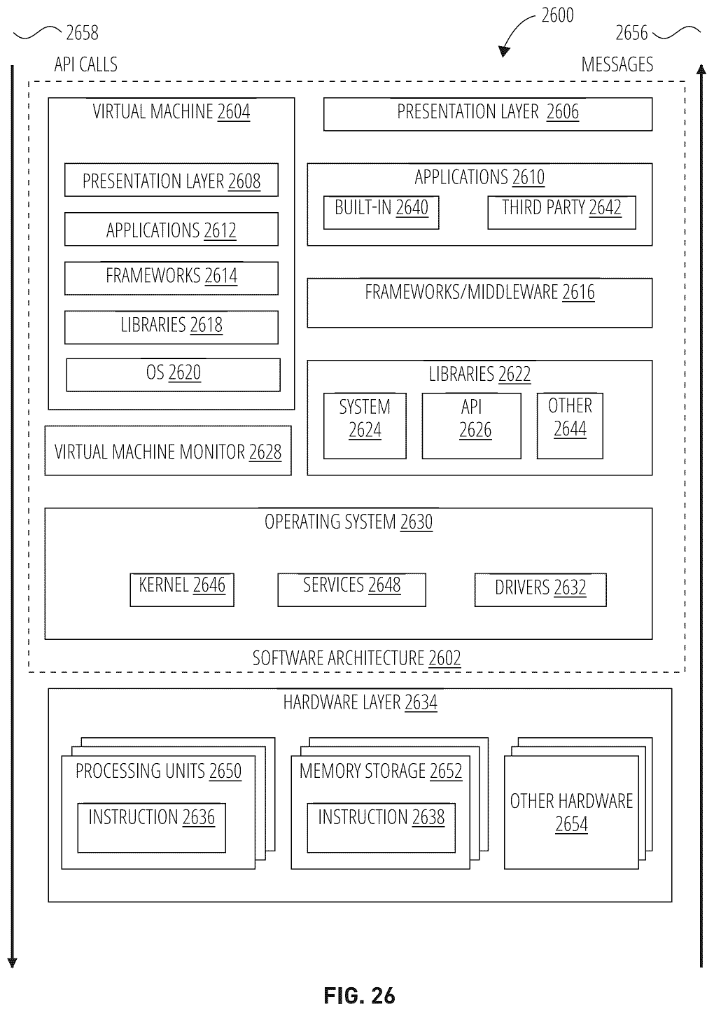

FIG. 26 is a block diagram illustrating an example of a software architecture 2602 that may be installed on a machine, according to some example embodiments. FIG. 26 is merely a non-limiting example of software architecture, and it will be appreciated that many other architectures may be implemented to facilitate the functionality described herein. The software architecture 2602 may be executing on hardware such as a machine 2500 of FIG. 25 that includes, among other things, processors 2504, memory/storage 2506, and input/output (I/O) components 2518. A representative hardware layer 2634 is illustrated and can represent, for example, the machine of FIG. 25. The representative hardware layer 2634 comprises one or more processing units 2650 having associated executable instructions 2636. The executable instructions 2636 represent the executable instructions of the software architecture 2602. The hardware layer 2634 also includes memory or memory storage 2652, which also have the executable instructions 2638. The hardware layer 2634 may also comprise other hardware 2654, which represents any other hardware of the hardware layer 2634 such as the other hardware illustrated as part of the machine 2500.

In the example architecture of FIG. 26, the software architecture 2602 may be conceptualized as a stack of layers, where each layer provides particular functionality. For example, the software architecture 2602 may include layers such as an operating system 2630, libraries 2618, frameworks/middleware 2616, applications 2610, and a presentation layer 2608. Operationally, the applications 2610 or other components within the layers may invoke API calls 2658 through the software stack and receive a response, returned values, and so forth (illustrated as messages 2656) in response to the API calls 2658. The layers illustrated are representative in nature, and not all software architectures have all layers. For example, some mobile or special-purpose operating systems may not provide a frameworks/middleware 2616 layer, while others may provide such a layer. Other software architectures may include additional or different layers.

The operating system 2630 may manage hardware resources and provide common services. The operating system 2630 may include, for example, a kernel 2646, services 2648, and drivers 2632. The kernel 2646 may act as an abstraction layer between the hardware and the other software layers. For example, the kernel 2646 may be responsible for memory management, processor management (e.g., scheduling), component management, networking, security settings, and so on. The services 2648 may provide other common services for the other software layers. The drivers 2632 may be responsible for controlling or interfacing with the underlying hardware. For instance, the drivers 2632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2618 may provide a common infrastructure that may be utilized by the applications 2610 and/or other components and/or layers. The libraries 2618 typically provide functionality that allows other software modules to perform tasks in an easier fashion than by interfacing directly with the underlying operating system 2630 functionality (e.g., kernel 2646, services 2648 or drivers 2632). The libraries 2618 or 2622 may include system libraries 2624 (e.g., C standard library) that may provide functions such as memory allocation functions, string manipulation functions, mathematic functions, and the like. In addition, the libraries 2618 or 2622 may include API libraries 2626 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 2618 or 2622 may also include a wide variety of other libraries 2644 to provide many other APIs to the applications 2610 or applications 2612 and other software components/modules.

The frameworks 2614 (also sometimes referred to as middleware) may provide a higher-level common infrastructure that may be utilized by the applications 2610 or other software components/modules. For example, the frameworks 2614 may provide various graphical user interface functions, high-level resource management, high-level location services, and so forth. The frameworks 2614 may provide a broad spectrum of other APIs that may be utilized by the applications 2610 and/or other software components/modules, some of which may be specific to a particular operating system or platform.

The applications 2610 include built-in applications 2640 and/or third-party applications 2642. Examples of representative built-in applications 2640 may include, but are not limited to, a home application, a contacts application, a browser application, a book reader application, a location application, a media application, a messaging application, or a game application.

The third-party applications 2642 may include any of the built-in applications 2640 as well as a broad assortment of other applications. In a specific example, the third-party applications 2642 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 2642 may invoke the API calls 2658 provided by the mobile operating system such as the operating system 2630 to facilitate functionality described herein.

The applications 2610 may utilize built-in operating system functions, libraries (e.g., system libraries 2624, API libraries 2626, and other libraries 2644), or frameworks/middleware 2616 to create user interfaces to interact with users of the system. Alternatively, or additionally, in some systems, interactions with a user may occur through a presentation layer, such as the presentation layer 2608. In these systems, the application/module “logic” can be separated from the aspects of the application/module that interact with the user.

Some software architectures utilize virtual machines. In the example of FIG. 26, this is illustrated by a virtual machine 2604. The virtual machine 2604 creates a software environment where applications/modules can execute as if they were executing on a hardware machine. The virtual machine 2604 is hosted by a host operating system (e.g., the operating system 2630) and typically, although not always, has a virtual machine monitor 2628, which manages the operation of the virtual machine 2604 as well as the interface with the host operating system (e.g., the operating system 2630). A software architecture executes within the virtual machine 2604, such as an operating system 2630, libraries 2618, frameworks/middleware 2616, applications 2612, or a presentation layer 2608. These layers of software architecture executing within the virtual machine 2604 can be the same as corresponding layers previously described or may be different.

### Example Embodiments

Embodiment 1 is a non-transitory computer-readable storage medium storing instructions that, when executed by at least one processor, cause the at least one processor to perform operations comprising configuring a universal server to: transmit, to one or more universal hosts, asset and scene information to generate one or more local scene graphs, each local scene graph of the one or more local scene graphs replicating a scene graph associated with a simulation running at the universal server, each local scene graph of the one or more local scene graphs being associated with a respective local simulation running at a respective universal host of the one or more universal hosts; upon receiving input from the one or more universal hosts: update an internal state based on the received input; generate commands encoding changes to an output state; and transmit the commands to the one or more universal hosts for updating each of the one or more local scene graphs at the respective universal hosts, at least one local scene graph of the one or more local scene graphs to be rendered at a local device associated with its respective universal host; wherein the universal server and the one or more universal hosts are applications.

In Embodiment 2, the subject matter of Embodiment 1 includes, wherein the changes to an output state are generated based on the universal server running the simulation based on the input received from the one or more universal hosts.

In Embodiment 3, the subject matter of Embodiments 1-2 includes, wherein: asset information comprises assets or asset location information; each asset of the assets is associated with a first granularity level of a plurality of granularity levels; each command of the commands is associated with a second granularity level of the plurality of granularity levels; and the plurality of granularity levels comprise at least a high level and a low level.

In Embodiment 4, the subject matter of Embodiments 1-3 includes, wherein a universal host of the one or more universal hosts maintains one or more partial scene graphs, wherein: each partial scene graph of the one or more partial scene graphs corresponds to part of a local scene graph associated with the universal host; each partial scene graph of the one or more partial scene graphs is associated with a viewpoint, the partial scene graph comprising one of at least objects visible from the viewpoint and viewpoint-specific graphic effects; and each partial scene graph can be rendered at a local device associated with the universal host.

In Embodiment 5, the subject matter of Embodiments 3-4 includes, wherein assets comprise high level assets and low level assets, and wherein: high level assets comprise one or more of at least meshes, materials, textures, shader information, animation rig information, animation clips, animation graphs, fonts, audio clips, video clips, sprites, prefabs, UI elements, component data, script byte code, lighting representations, or blend shapes; and low level assets comprise one or more of pipeline state objects (PSOs), buffers, shader resources, sampler state or render targets.

In Embodiment 6, the subject matter of Embodiments 3-5 includes, wherein scene data comprises scene graph nodes and components associated with scene graph nodes, each of the components comprising one or more of a property, data, or a behavior associated with a respective scene graph node of the scene graph nodes.

In Embodiment 7, the subject matter of Embodiments 3-6 includes, wherein: the commands comprise high level commands including one or more of at least asset updates or component updates; the high level commands can be converted, by local simulations at the one or more universal hosts, to low level commands; and the low level commands can be converted to application programming interface (API) calls on one or more local devices associated with the one or more universal hosts.

In Embodiment 8, the subject matter of Embodiments 1-7 includes, wherein input received from the one or more universal hosts comprises information associated with one or more of at least mouse clicks, pointer movement, button presses, keystrokes, detected joint positions or head transforms.

In Embodiment 9, the subject matter of Embodiments 7-8 includes, wherein the input further comprises output of command prediction routines or extrapolation routines associated with the local simulations running at the one or more universal hosts.

In Embodiment 10, the subject matter of Embodiments 1-9 includes, wherein transmitting an asset of the assets to a universal host of the one or more universal hosts comprises determining whether the asset meets one or more of a plurality of criteria, the plurality of criteria comprising determining whether a resolution of the asset transgresses a predetermined threshold, determining whether the asset is needed for the scene graph, determining an apparent size of the asset, or determining if the asset is visible with respect to a predetermined viewpoint.

In Embodiment 11, the subject matter of Embodiments 1-10 includes, wherein the universal server transmitting the commands to the one or more universal hosts uses a graph comprising one or more command handler operators, each command handler operator of the one or more command handler operators being configured to perform one of at least filtering the commands, multiplexing the commands, adding a new command, or transmitting data.

In Embodiment 12, the subject matter of Embodiments 10-11 includes, the operations further comprising: enabling a plurality of universal servers and a plurality of universal hosts to be arranged in a one or more of a plurality of communication configurations, each communication configuration of the plurality of communication configurations being enabled to be dynamically updated, and each communication configuration of the plurality of communication configurations using one or more command handler operators.

Embodiment 13 is at least one machine-readable medium including instructions that, when executed by processing circuitry, cause the processing circuitry to perform operations to implement any of Embodiments 1-12.

Embodiment 14 is an apparatus comprising means to implement any of Embodiments 1-12.

Embodiment 15 is a system to implement any of Embodiments 1-12.

Embodiment 16 is a computer-implemented method to implement any of Embodiments 1-12.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

“SHADER” in this context refers to a program that runs on a GPU, a CPU, a TPU and so forth. In the following, a non-exclusive listing of types of shaders is offered. Shader programs may be part of a graphics pipeline. Shaders may also be compute shaders or programs that perform calculations on a CPU or a GPU (e.g., outside of a graphics pipeline, etc.). Shaders may perform calculations that determine pixel properties (e.g., pixel colors). Shaders may refer to ray tracing shaders that perform calculations related to ray tracing. A shader object may (e.g., an instance of a shader class) may be a wrapper for shader programs and other information. A shader asset may refer to a shader file (or a “.shader” extension file), which may define a shader object.

“ASSETS” in this context refer to meshes, materials, textures, shader and/or animation rig information, fonts, audio clips, sprites, prefabs, UI elements, video clips (2D, stereo, spatial), navigation meshes, component data, script byte code, lighting representations (light probes, environment probes, lightmaps, etc.), blend shapes, animation clips, animation graphs, collision meshes and materials, low-level GPU assets. Textures can be of one or more types (e.g., 1D,2D,3D, cubemap) in both native (compressed) and universal formats, shaders in various representations (bytecode, source code, human readable encodings (e.g., MaterialX, UsdShade)). Low-level GPU assets include pipeline state objects (PSOs), buffers (e.g., texture buffers, vertex buffers, index buffers, constant buffers, compute buffers), shader resources (SRVs and UAVs), sampler state, render targets, and so forth.

“ENTITIES” in this context refer to game objects and/or scene graph nodes, among other entity types. Each entity includes a 2D or 3D transform (in the context of a transform hierarchy), a name, ID, lifecycle state information such as active/enabled/visible flags, debug information, and/or additional hierarchical relationships (e.g., namespace and/or physics hierarchies separate from the transform hierarchy).

“COMPONENTS (SCENE DATA)” in this context refer to modular elements associated with entities. Components can be individually added to and/or removed from entities. When added to an entity, a component can activate or turn off one or more specific behaviors (e.g., rendering a mesh, playing a sound, etc.). A component is characterized by properties and/or data (e.g., mesh information, material information, shader property values, etc.), simulation behavior and/or rendering behavior (behaviors being encoded as functions associated with the component). For example, a MeshRenderer component includes properties and/or data such as a reference to a mesh (an asset), a material (an asset) to be used to render that mesh, and/or one or more flags indicating if the component is enabled and/or visible at a given time. An example ParticleSystem component includes a mesh, a material and/or hundreds of properties (values, curves, colors, enums, and so forth) associated with lifetime information, delay information, speed, start and/or end color, forces, current time, and so forth. An example light component can include a color and/or a position. In some embodiments, components can be output components. Output components contribute to the final output, such as rendering, audio and/or other output signals. Output components are replicated over to a remote host to recreate the scene. Output components include, for example: Camera, Light, MeshRenderer, SkinnedMeshRenderer, SpriteRenderer, ParticleSystem, ParticleRenderer, LineRenderer, TrailRenderer, TextRenderer, CanvasRenderer, SpriteMask, ReflectionProbe, LOD Group, Terrain, Skybox, OcclusionCulling, PostProcessing, Visual Effects (LenseFlare, Projector, Decal), AudioSource, Audio Listener, UI ComponentsTerrain, Tilemap, VideoPlayback, and so forth. In some embodiments, components can be simulation components that relate to the logic of an application, but not to the output of an application. Simulation components can be omitted from sync-ing operations (or included if desired). Simulation components include, for example: Animator, NavMeshAgent, NavMeshObstacle, EventSystem, CharacterController, user-created script components that implement particular games (e.g., MonoBehaviours, etc.), and so forth. Additional components of interest can include colliders, rigid bodies, joints, forces, or animators. Colliders, rigid bodies, joints and/or forces can be included in sync-ing operations (e.g., between server and remote host, etc.) to enable host-side input ray tracing and/or a shared physics world. Animators can be simulation components (e.g., if host overhead is acceptable), or, alternatively, be considered output components (e.g., if sync-ing them over the network is acceptable).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A non-transitory computer-readable storage medium storing instructions that, when executed by at least one processor, cause the at least one processor to perform operations comprising configuring a universal server to:
transmit, to one or more universal hosts, asset and scene information to generate one or more local scene graphs, each local scene graph of the one or more local scene graphs replicating a scene graph associated with a simulation running at the universal server, each local scene graph of the one or more local scene graphs being associated with a respective local simulation running at a respective universal host of the one or more universal hosts;
upon receiving input from the one or more universal hosts:
update an internal state based on the received input;
generate commands encoding changes to an output state; and
transmit the commands to the one or more universal hosts for updating each of the one or more local scene graphs at the respective universal hosts, at least one local scene graph of the one or more local scene graphs to be rendered at a local device associated with its respective universal host;
wherein the universal server and the one or more universal hosts are applications.

2. The non-transitory computer-readable storage medium of claim 1, wherein the changes to an output state are generated based on the universal server running the simulation based on the input received from the one or more universal hosts.

3. The non-transitory computer-readable storage medium of claim 1, wherein:
asset information comprises assets or asset location information;
each asset of the assets is associated with a first granularity level of a plurality of granularity levels;
each command of the commands is associated with a second granularity level of the plurality of granularity levels; and
the plurality of granularity levels comprise at least a high level and a low level.

4. The non-transitory computer-readable storage medium of claim 1, wherein a universal host of the one or more universal hosts maintains one or more partial scene graphs, wherein:
each partial scene graph of the one or more partial scene graphs corresponds to part of a local scene graph associated with the universal host;
each partial scene graph of the one or more partial scene graphs is associated with a viewpoint, the partial scene graph comprising one of at least objects visible from the viewpoint and viewpoint-specific graphic effects; and
each partial scene graph can be rendered at a local device associated with the universal host.

5. The non-transitory computer-readable storage medium of claim 3, wherein assets comprise high level assets and low level assets, and wherein:
high level assets comprise one or more of at least meshes, materials, textures, shader information, animation rig information, animation clips, animation graphs, fonts, audio clips, video clips, sprites, prefabs, UI elements, component data, script byte code, lighting representations, or blend shapes; and
low level assets comprise one or more of pipeline state objects (PSOs), buffers, shader resources, sampler state or render targets.

6. The non-transitory computer-readable storage medium of claim 3, wherein scene data comprises scene graph nodes and components associated with scene graph nodes, each of the components comprising one or more of a property, data, or a behavior associated with a respective scene graph node of the scene graph nodes.

7. The non-transitory computer-readable storage medium of claim 3, wherein:
the commands comprise high level commands including one or more of at least asset updates or component updates;
the high level commands can be converted, by local simulations at the one or more universal hosts, to low level commands; and
the low level commands can be converted to application programming interface (API) calls on one or more local devices associated with the one or more universal hosts.

8. The non-transitory computer-readable storage medium of claim 1, wherein input received from the one or more universal hosts comprises information associated with one or more of at least mouse clicks, pointer movement, button presses, keystrokes, detected joint positions or head transforms.

9. The non-transitory computer-readable storage medium of claim 7, wherein the input further comprises output of command prediction routines or extrapolation routines associated with the local simulations running at the one or more universal hosts.

10. The non-transitory computer-readable storage medium of claim 1, wherein transmitting an asset of the assets to a universal host of the one or more universal hosts comprises determining whether the asset meets one or more of a plurality of criteria, the plurality of criteria comprising determining whether a resolution of the asset transgresses a predetermined threshold, determining whether the asset is needed for the scene graph, determining an apparent size of the asset, or determining if the asset is visible with respect to a predetermined viewpoint.

11. The non-transitory computer-readable storage medium of claim 1, wherein the universal server transmitting the commands to the one or more universal hosts uses a graph comprising one or more command handler operators, each command handler operator of the one or more command handler operators being configured to perform one of at least filtering the commands, multiplexing the commands, adding a new command, or transmitting data.

12. The non-transitory computer-readable storage medium of claim 10, the operations further comprising:
enabling a plurality of universal servers and a plurality of universal hosts to be arranged in a one or more of a plurality of communication configurations,
each communication configuration of the plurality of communication configurations being enabled to be dynamically updated, and
each communication configuration of the plurality of communication configurations using one or more command handler operators.

13. A computer-implemented method comprising configuring a universal server to:
transmit, to one or more universal hosts, asset and scene information to generate one or more local scene graphs, each local scene graph of the one or more local scene graphs replicating a scene graph associated with an internal simulation running at the universal server, each local scene graph of the one or more local scene graphs being associated with a respective local simulation running at a respective universal host of the one or more universal hosts;
upon receiving input from the one or more universal hosts:
update an internal state based on the received input;
generate commands encoding changes to an output state; and
transmit the commands to the one or more universal hosts for updating each of the one or more local scene graphs at the respective universal hosts, at least one local scene graph of the one or more local scene graphs to be rendered at a local device associated with its respective universal host;
wherein the universal server and the one or more universal hosts are applications.

14. The computer-implemented method of claim 13, wherein:
asset information comprises assets or asset location information;
each asset of the assets is associated with a first granularity level of a plurality of granularity levels;
each command of the commands is associated with a second granularity level of the plurality of granularity levels; and
the plurality of granularity levels comprise at least a high level and a low level.

15. The computer-implemented method of claim 13, wherein a universal host of the one or more universal hosts maintains one or more partial scene graphs, wherein:
each partial scene graph of the one or more partial scene graphs corresponds to part of a local scene graph associated with the universal host;
each partial scene graph of the one or more partial scene graphs is associated with a viewpoint, the partial scene graph comprising one of at least objects visible from the viewpoint and viewpoint-specific graphic effects; and
each partial scene graph can be rendered at a local device associated with the universal host.

16. The computer-implemented method of claim 13, wherein scene data comprises scene graph nodes and components associated with scene graph nodes, each of the components comprising one or more of a property, data, or a behavior associated with a respective scene graph node of the scene graph nodes.

17. The computer-implemented method of claim 13, wherein:
the commands comprise high level commands including one or more of at least asset updates or component updates;
the high level commands can be converted, by local simulations at the one or more universal hosts, to low level commands; and
the low level commands can be converted to application programming interface (API) calls on one or more local devices associated with the one or more universal hosts.

18. The computer-implemented method of claim 13, wherein the input comprises output of command prediction routines or extrapolation routines associated with local simulations running at the one or more universal hosts.

19. The computer-implemented method of claim 13, further comprising:
enabling a plurality of universal servers and a plurality of universal hosts to be arranged in a one or more of a plurality of communication configurations,
each communication configuration of the plurality of communication configurations being enabled to be dynamically updated, and
each communication configuration of the plurality of communication configurations using one or more command handler operators.

20. A system comprising:
one or more computer processors;
one or more computer memories; and
a set of instructions stored in the one or more computer memories, the set of instructions configuring the one or more computer processors to perform operations, the operations comprising configuring a universal server to:
transmit, to one or more universal hosts, asset and scene information to generate one or more local scene graphs, each local scene graph of the one or more local scene graphs replicating a scene graph associated with an internal simulation running at the universal server, each local scene graph of the one or more local scene graphs being associated with a respective local simulation running at a respective universal host of the one or more universal hosts;
upon receiving input from the one or more universal hosts:
update an internal state based on the received input;
generate commands encoding changes to an output state; and
transmit the commands to the one or more universal hosts for updating each of the one or more local scene graphs at the respective universal hosts, at least one local scene graph of the one or more local scene graphs to be rendered at a local device associated with its respective universal host;
wherein the universal server and the one or more universal hosts are applications.
